(19) United States
(12) Patent Application Publication
(10) Pub. No.: US 2016/0072893 A1
(43) Pub. Date: Mar. 10, 2016

(54) COMMUNICATIONS METHOD, SYSTEM, AND COMPUTER PRODUCT

(71) Applicant: FUJITSU LIMITED, Kawasaki-shi (JP)

(72) Inventors: Takahisa Suzuki, Yokohama (JP); Koichiro Yamashita, Hachioji (JP); Hiromasa Yamauchi, Kawasaki (JP); Toshiya Otomo, Kawasaki (JP)

(73) Assignee: FUJITSU LIMITED, Kawasaki-shi (JP)

(21) Appl. No.: 14/944,608

(22) Filed: Nov. 18, 2015

Related U.S. Application Data
(63) Continuation of application No. PCT/JP2013/064540, filed on May 24, 2013.

(51) Int. Cl. H04L 29/08; H04L 12/26; H04L 12/46

(52) U.S. Cl. CPC H04L 67/12; H04L 12/46; H04L 43/08

(57) ABSTRACT

A communications method includes transmitting a sensor data collection request to a second network that includes a group of nodes having sensors, the transmitting being performed by a first communications apparatus of plural of communications apparatuses configured to communicate through a first network; and transmitting reception information to the first communications apparatus via the first network, when sensor data is received that is transferred by multihop communication among nodes in the second network and corresponds to the sensor data collection request, the reception information indicating reception of the sensor data, and the transmitting of the reception information being performed by a second communications apparatus of the plural communications apparatuses.

### CROSS REFERENCE TO RELATED APPLICATIONS

This application is a continuation application of International Application PCT/JP2013/064540, filed on May 24, 2013 and designating the U.S., the entire contents of which are incorporated herein by reference.

### FIELD

The embodiments discussed herein are related to a communications method, a system, and a computer product.

### BACKGROUND

Conventionally, there are networks (wireless sensor networks (WSN)) in which nodes having a sensor are interspersed in a given space and work in concert to enable physical states to be obtained. Each node in the network transmits and receives data by multihop communication. Further, there is technology called energy harvesting that generates electrical power using energy obtained according to the environment where installed. There is also technology that transmits acknowledgement (ACK) to a transmission side from a receiving side when communication ends and thereby, conveys to the transmission side that data has arrived properly.

According to a related technology, for example, a data collection request is transmitted downstream from a base station and a transfer of the data collection request to a module further downstream by the module downstream from the base station is regarded to be ACK for the transmission of the data collection request from the base station to the downstream module (for example, refer to Japanese Laid-Open Patent Publication No. 2005-092653).

Nonetheless, according to the conventional technologies, when the data of the sensors of the nodes interspersed in a given space are collected, even if the communications apparatus that received the data transmits ACK to the node, the node may be unable to receive the ACK consequent to a strict communications constraint. For example, nodes interspersed in a given space may be unable to receive the ACK consequent to interference by radio waves from other nodes within a close distance from the nodes. Further, for example, there may be cases where nodes that use power generated by energy harvesting are unable to receive the ACK consequent to insufficient power and cases where even if the ACK is received, the ACk cannot be transmitted to other nodes consequent to insufficient power. In a case where the ACK cannot be received, for example, even if a communications apparatus receives data, the data may be retransmitted since the ACK cannot be received.

### SUMMARY

According to an aspect of an embodiment, a communications method includes transmitting a sensor data collection request to a second network that includes a group of nodes having sensors, the transmitting being performed by a first communications apparatus of plural of communications apparatuses configured to communicate through a first network; and transmitting reception information to the first communications apparatus via the first network, when sensor data is received that is transferred by multihop communication among nodes in the second network and corresponds to the sensor data collection request, the reception information indicating reception of the sensor data, and the transmitting of the reception information being performed by a second communications apparatus of the plural communications apparatuses.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an operation example of a system according to a first embodiment;

FIG. 2 is a diagram depicting a connection example of a sensor network system;

FIG. 3 is a block diagram of hardware configuration of a user terminal;

FIG. 4 is a block diagram of hardware configuration of a data collection requesting apparatus;

FIG. 5 is a block diagram of hardware configuration of a data aggregating apparatus;

FIG. 6 is a block diagram of hardware configuration of a node;

FIG. 7 is a block diagram of a functional configuration of the sensor network system according to the first embodiment;

FIG. 8 is a diagram depicting an example of packet formats;

FIG. 9 is a diagram (part 1) of an operation example at the time of calibration request transmission;

FIG. 10 is a diagram (part 2) of the operation example at the time of calibration request transmission;

FIG. 11 is a diagram (part 3) of the operation example at the time of calibration request transmission;

FIG. 12 is a diagram (part 1) of an operation example at the time of data collection request transmission;

FIG. 13 is a diagram (part 2) of the operation example at the time of data collection request transmission;

FIG. 14 is a diagram (part 3) of the operation example at the time of data collection request transmission;

FIG. 15 is a diagram (part 4) of the operation example at the time of data collection request transmission;

FIG. 16 is a flowchart of one example of a procedure of a calibration request instructing process by the user terminal according to the first embodiment;

FIG. 17 is a flowchart of one example of a procedure of a data collection request instructing process by the user terminal;

FIG. 18 is a flowchart of one example of a procedure of a request instructing process by the data collection requesting apparatus;

FIG. 19 is a flowchart of one example of a procedure of a packet process by a node;

FIG. 20 is a flowchart of one example of a procedure of a data collection suspension instruction receiving process by the data aggregating apparatus;

FIG. 21 is a flowchart of one example of a procedure of a packet receiving process by the data aggregating apparatus;

FIG. 22 is a flowchart of one example of a procedure of a calibration request process by the data aggregating apparatus;

FIG. 23 is a flowchart of one example of a procedure of a calibration starting process by the data aggregating apparatus;

FIG. 24 is a flowchart (part 1) of an example of a procedure of a calibration aggregating process by the data aggregating apparatus;

FIG. 25 is a flowchart (part 2) of the example of the procedure of the calibration aggregating process by the data aggregating apparatus;

FIG. 26 is a flowchart of one example of a procedure of a data collection request process by the data aggregating apparatus;

FIG. 27 is a flowchart (part 1) of an example of a procedure of a data aggregating process by the data aggregating apparatus;

FIG. 28 is a flowchart (part 2) of the example of the procedure of the data aggregating process by the data aggregating apparatus;

FIG. 29 is a block diagram of a functional example of the sensor network system according to a second embodiment;

FIG. 30 is a flowchart of one example of the procedure of the calibration request instructing process by the user terminal according to the second embodiment;

FIG. 31 is a flowchart of one example of a procedure of a recalibration request instructing process by the user terminal;

FIG. 32 is a flowchart of one example of a procedure of a node ID transmitting process by the data aggregating apparatus; and

FIG. 33 is a flowchart of one example of a procedure of a given count updating process by the data aggregating apparatus.

### DESCRIPTION OF EMBODIMENTS

Embodiments of a communications method, a system, and a communications program of the disclosure will be described in detail with reference to the accompanying drawings.

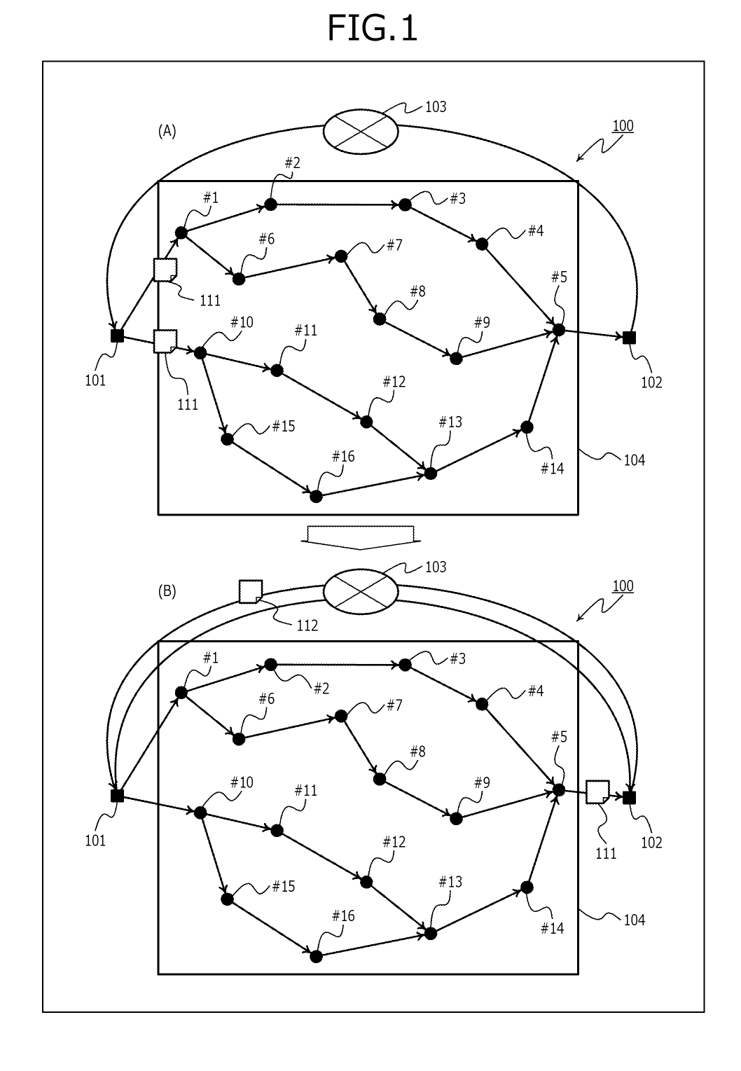

FIG. 1 is a diagram depicting an operation example of a system according to a first embodiment. A system 100 includes a communications apparatus 101 that is a first communications apparatus, a communications apparatus 102 that is a second communications apparatus, and nodes #1 to #16 as a node group having sensors. The communications apparatuses 101, 102 are connected via a network 103 that is a first network. The nodes #1 to #16 are included in a network 104 that is a second network.

Each node is a communications apparatus having an energy harvesting element that generates power using energy obtained according to the environment in which the node is installed, and operating using the power generated by the energy harvesting element and stored by a charging unit. Each node is disposed within a given region R. The given region, for example, is a region filled with a substance such as soil, water, air, etc. Each node activates when sufficiently charged and performs intermittent operation of transmitting data and sleeping. Further, since the power generated by the energy harvesting element is limited, each node uses short range radio, which has low power consumption, and transmits and receives data by multihop communication.

Each node has a sensor and obtains by the sensor, measurement data concerning temperature, humidity, stress, etc. in the given region.

The communications apparatus 101 issues a sensor data collection request to the network 104. The communications apparatus 102 receives sensor data in response to the sensor data collection request. The sensor data are aggregated at a server through the communications apparatus 102 and used for analysis processing.

The network 103 connects plural computers by wired or wireless signals. The network 103 has a low possibility of communication being interrupted and is quite reliable in performing communication. On the other hand, the network 104 uses short range radio to connect plural nodes.

Thus, in order for the communications apparatuses 101, 102 to reliably obtain sensor data, after the communications apparatus 102 receives the data, the communications apparatus 102 transmits to the communications apparatus 101, a reception signal serving as ACK and indicating that the data has been received. Nonetheless, when attempting to transmit the reception signal to the communications apparatus 101 by multihop communication via the nodes, the communications constraint on the nodes may be strict whereby, the nodes may unable to receive the ACK. Here, a communications constraint is a constraint on communication. For example, since the nodes are interspersed in a given space, a node may be unable to receive the ACK consequent to interference of radio waves from other nodes within a close distance from the nodes. Further, since the nodes operate by the energy harvesting element, a node may be unable to receive the ACK consequent to insufficient power, and the node may be unable to transmit the ACK to another node consequent to insufficient power.

Thus, in the system 100 according to the first embodiment, the communications apparatus 101 transmits a data collection request to the node group and the communications apparatus 102 uses the network 103 to directly transmit reception information to the communications apparatus 101 after receiving the data from the node group. As a result, the system 100 is able to bypass the node group, which has strict communications constraints, and notify the communications apparatus 101 of the arrival of the data. Hereinafter, an operation example of the system 100 will be described with reference to (A) in FIG. 1 and (B) in FIG. 1.

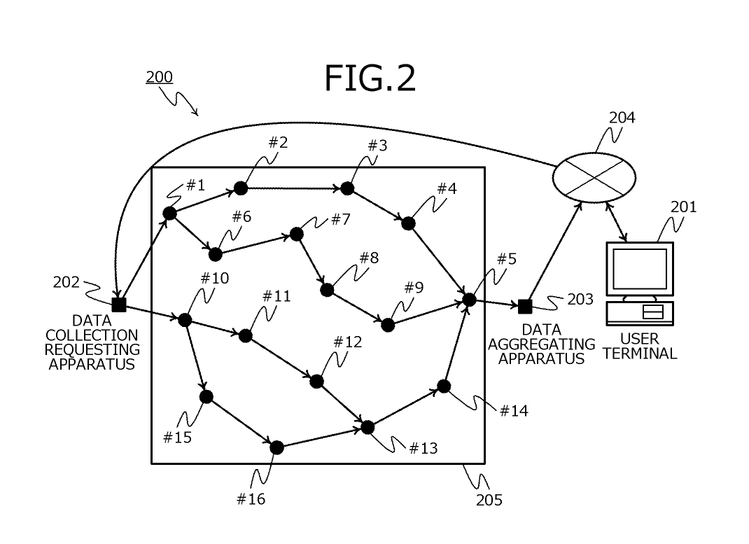

In (A) of FIG. 1, the communications apparatus 101 transmits a sensor data collection request 111 to the second network 104 that includes the node group having sensors. In (B) of FIG. 1, after the communications apparatus 102 receives the sensor data collection request 111, the communications apparatus 102 transmits to the communications apparatus 101 via the network 103, reception information 112 indicating that the sensor data collection request 111 has been received. An example of a sensor network system 200 to which the system 100 is applied will be described with reference to FIG. 2.

FIG. 2 is a diagram depicting a connection example of the sensor network system. The sensor network system 200 includes a user terminal 201, a data collection requesting apparatus 202, a data aggregating apparatus 203 and node #1 to node #16 forming a node group. The user terminal 201, the data collection requesting apparatus 202, and the data aggregating apparatus 203 are connected by a network 204. Node #1 to node #16 are included in a network 205. Here, the user terminal 201 corresponds to the communications apparatus 101. Further, the data aggregating apparatus 203 corresponds to the communications apparatus 102. Among functions of the communications apparatus 101, the data collection requesting apparatus 202 has a function of making a data collection request to the network 205, as a third communications apparatus. Further, the network 204 corresponds to the network 103 and the network 205 corresponds to the network 104.

The user terminal 201 is a computer used by a user of the sensor network system 200. The user terminal 201 transmits a data collection instruction to the data collection requesting apparatus 202, consequent to a user instruction.

The data collection requesting apparatus 202 is an apparatus that transmits a data collection request to nearby nodes. Each node upon receiving the data collection request, activates the sensor thereof, performs measurement, and transmits the data collection request and collected data to nearby nodes. The data aggregating apparatus 203 aggregates the collected data received and transmits the aggregated data to the user terminal 201.

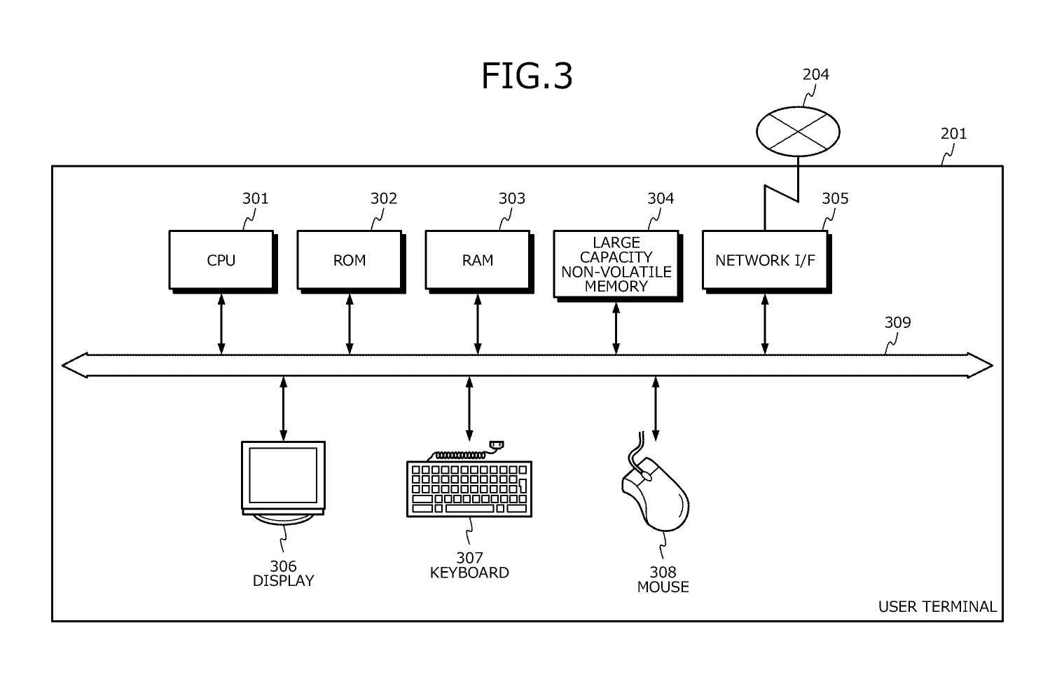

The network 204 connects plural computers. The network 205, for example, is a local area network (LAN), a wide area network (WAN), etc. Hardware configuration of the user terminal 201, the data collection requesting apparatus 202, the data aggregating apparatus 203, and the nodes will be described with reference to FIG. 3 to FIG. 6.

FIG. 3 is a block diagram of hardware configuration of the user terminal. In FIG. 3, the user terminal 201 includes a central processing unit (CPU 301), read-only memory (ROM) 302, and random access memory (RAM 303). The user terminal 201 further includes large capacity non-volatile memory 304, and a network I/F 305. The user terminal 201 further includes a display 306, a keyboard 307, and a mouse 308. The CPU 301 to the mouse 308 are respectively connected by a bus 309.

The CPU 301 is a computation processing apparatus governing overall control of the user terminal 201. The ROM 302 is non-volatile memory storing therein programs such as a boot program. The RAM 303 is volatile memory used as a work area of the CPU 301.

The large capacity non-volatile memory 304 is a readable and writable storage apparatus and retains given data written thereto, even when power supply ceases. For example, a hard disk drive (HDD), flash memory, and the like are employed as the large capacity non-volatile memory 304.

The network I/F 305 is a control apparatus that administers an internal interface with the network 204 and controls the input and output of data from an external apparatus. More specifically, the network I/F 305 is connected to the network 204 through a communications line and is connected to other apparatus via the network 204. A modem, LAN adapter, and the like may be employed as the network I/F 305, for example.

The display 306 is an apparatus that displays data such as documents, images, and functional information in addition to a mouse cursor, icons, and toolboxes. A cathode ray tube (CRT), thin film transistor (TFT) liquid crystal display, plasma display, and the like may be employed as the display 306, for example.

The keyboard 307 is an apparatus that inputs data and has keys for inputting text, numerals, various instructions, etc. Further, the keyboard 307 may be a touch panel input pad, a numeric pad, and the like. The mouse 308 is an apparatus that moves and selects a range of the mouse cursor, moves and changes the size of windows, etc. The mouse 308 may be a trackball, a joystick, and like provided the device has the same functions as a pointing device.

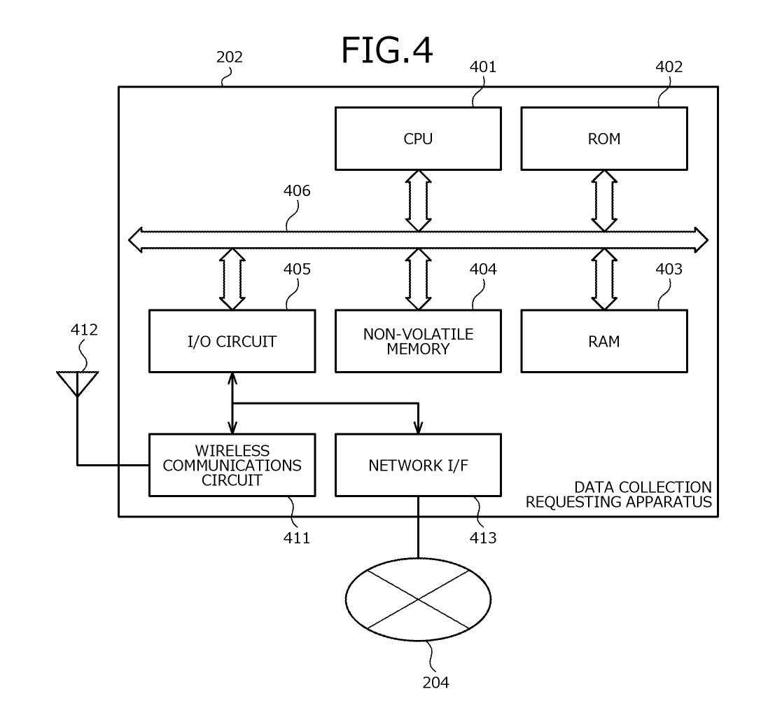

FIG. 4 is a block diagram of hardware configuration of the data collection requesting apparatus. The data collection requesting apparatus 202 has a processor (CPU) 401, ROM 402, RAM 403, non-volatile memory 404, an interface input/output (I/O) circuit 405, a wireless communications circuit 411, an antenna 412, and a network I/F 413. The CPU 401 is a computation processing apparatus that governs overall control of the data collection requesting apparatus 202. Further, the data collection requesting apparatus 202 has a bus 406 connecting the CPU 401, the ROM 402, the RAM 403, the non-volatile memory 404, and the I/O circuit 405. Unlike the nodes, the data collection requesting apparatus 202 may operate based on an external power source, or may operate based on an internal power source. The non-volatile memory 404 is a readable and writable storage apparatus, and retains given data written thereto, even when power supply ceases. For example, flash memory may be employed as the non-volatile memory 404.

The I/O circuit 405 is further connected to the wireless communications circuit 411, the antenna 412, and the network I/F 413, whereby the data collection requesting apparatus 202 is able to wirelessly communicate with nearby nodes through the wireless communications circuit 411 and the antenna 412. The data collection requesting apparatus 202 is able to communicate with the user terminal 201 and the data aggregating apparatus 203 through the network 204, which is the Internet, etc., by an Internet Protocol (IP) process, etc. via the network I/F 413.

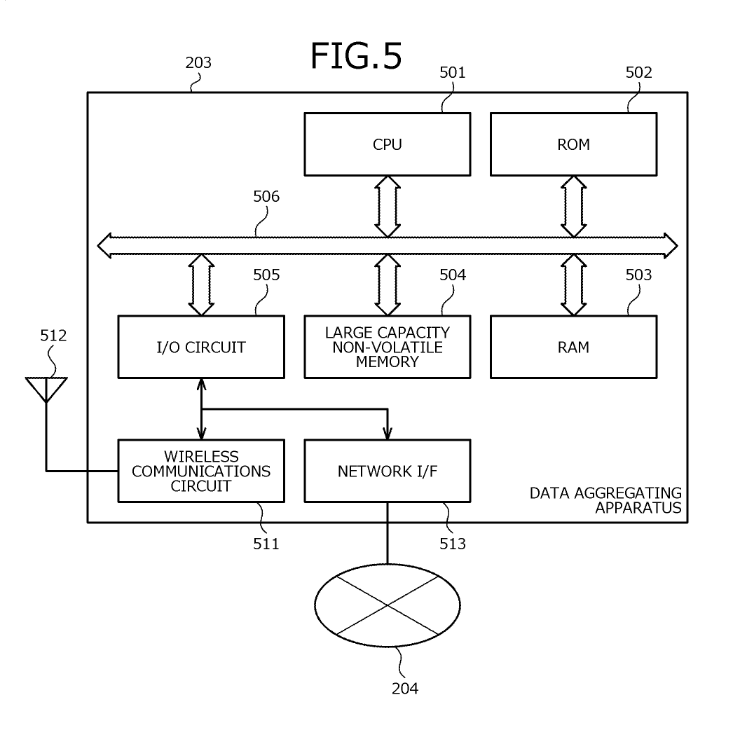

FIG. 5 is a block diagram of hardware configuration of the data aggregating apparatus. The data aggregating apparatus 203 has a CPU 501, ROM 502, RAM 503, large capacity non-volatile memory 504, an I/O circuit 505, a wireless communications circuit 511, an antenna 512, and a network I/F 513. The CPU 501 is a computation processing apparatus that governs overall control of the data aggregating apparatus 203. Further, the data aggregating apparatus 203 has a bus 506 connecting the CPU 501, the ROM 502, the RAM 503, the large capacity non-volatile memory 504, and the I/O circuit 505. Unlike the nodes, the data aggregating apparatus 203 may operate based on an external power source or may operate based on an internal power source. The large capacity non-volatile memory 504 is a readable and writable storage apparatus, and retains given data written thereto, even when power supply ceases. For example, an HDD, flash memory, and the like may be employed as the large capacity non-volatile memory 504.

The I/O circuit 505 is further connected to the wireless communications circuit 511, the antenna 512, and the network I/F 513, whereby, the data aggregating apparatus 203 is able to wirelessly communicate with nearby nodes through the wireless communications circuit 511 and the antenna 512. The data aggregating apparatus 203 is able to communicate with the user terminal 201 and the data collection requesting apparatus 202 through the network 204, which is the Internet, etc., by an IP process, etc., via the network I/F 513.

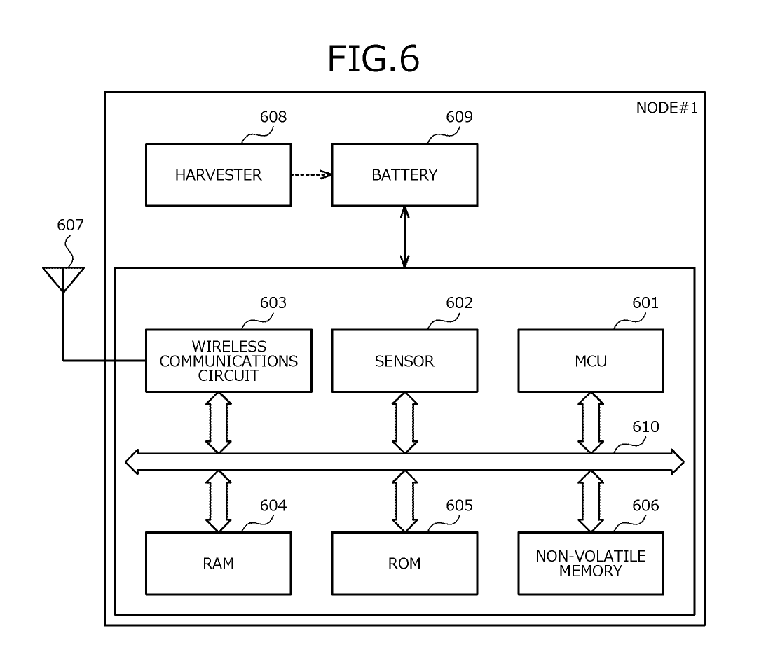

FIG. 6 is a block diagram of hardware configuration of a node. In the example depicted in FIG. 6, node #1 is taken as an example and hardware configuration of node #1 is depicted. Other nodes also have the same hardware configuration as node #1. Node #1 has microprocessor (hereinafter, micro control unit (MCU) 601, a sensor 602, a wireless communications circuit 603, RAM 604, ROM 605, non-volatile memory 606, an antenna 607, a harvester 608, and a battery 609. Node #1 has a bus 610 that connects the MCU 601, the sensor 602, the wireless communications circuit 603, the RAM 604, the ROM 605, and the non-volatile memory 606.

The MCU 601 is a computation processing apparatus that governs overall control of node #1. For example, the MCU 601 processes data related to detection by the sensor 602. The sensor 602 is an apparatus that detects a given change at the installation site. The sensor 602, for example, may be a piezoelectric element that detects voltage at the installation site, an element that detects temperature, a photoelectric element that detects light, and the like. The antenna 607 transmits and receives radio waves wirelessly communicated with a parent device. The wireless communications circuit 603 (radio frequency (RF)) outputs received wireless radio waves as a reception signal and transmits a transmission signal as wireless radio waves via the antenna 607. The wireless communications circuit 603 suffices to be a communications circuit employing short range radio capable of communicating with other nodes located within a vicinity of a few tens of centimeters.

The RAM 604 is a storage apparatus storing therein, transient data of processing by the MCU 60. The ROM 605 is a storage apparatus storing therein process programs executed by the MCU 601. The non-volatile memory 606 is a readable and writable storage apparatus, and retains given data written thereto, even when power supply ceases. For example, flash memory may be employed as the non-volatile memory 606.

The harvester 608 is the energy harvesting element described with reference to FIG. 1, and is an apparatus that generates power based on the external environment of the installation site of node #1, for example, energy changes such as changes in light, vibration, temperature, radio waves (received radio waves) and the like. Further, the harvester 608 may generate power according to the amount of change detected by the sensor 602. The battery 609 is an apparatus that stores the power generated by the harvester 608. In other words, node #1 does not require an external power supply and internally generates the power necessary for operation thereof.

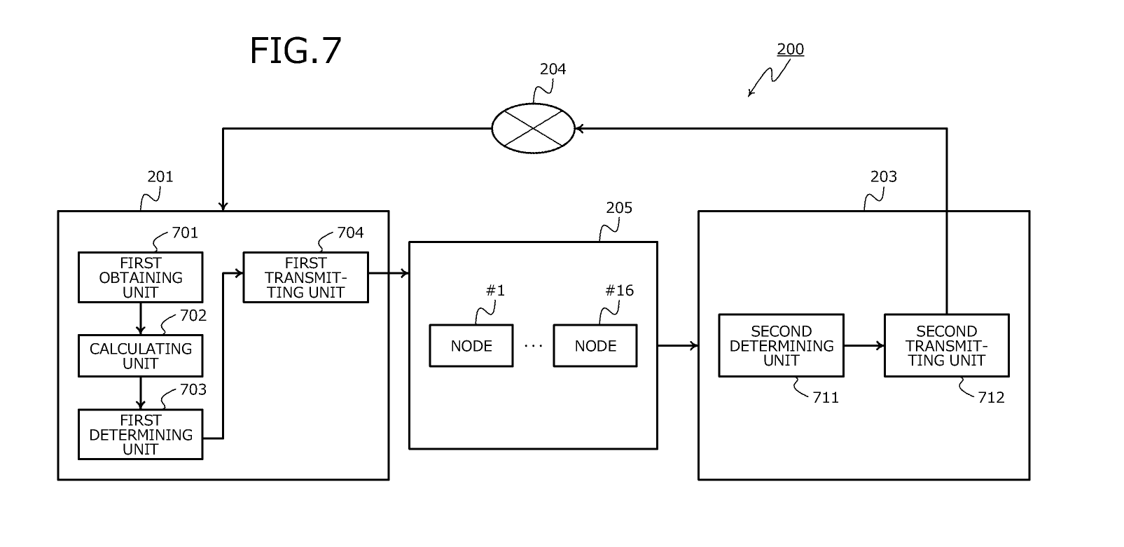

Functions of the sensor network system 200 will be described. FIG. 7 is a block diagram of a functional configuration of the sensor network system according to the first embodiment. The sensor network system 200 includes a first obtaining unit 701, a calculating unit 702, a first determining unit 703, a first transmitting unit 704, a second determining unit 711, and a second transmitting unit 712. The first obtaining unit 701 to the first transmitting unit 704 are functions of the user terminal 201. Further, the data collection requesting apparatus 202 may have the first transmitting unit 704. The second determining unit 711 and the second transmitting unit 712 are functions of the data aggregating apparatus 203.

Functions of the first obtaining unit 701 to the second transmitting unit 712 forming a control unit are realized by executing on the CPU 301 and the CPU 501, a program stored in a storage apparatus. A storage apparatus, more specifically, for example, is the ROM 302, the RAM 303, the large capacity non-volatile memory 304, the ROM 502, the RAM 503, and the large capacity non-volatile memory 504 depicted in FIGS. 3 to 5.

The first obtaining unit 701 obtains a hop count of a signal transmitted from the user terminal 201 and transferred by multihop communication among the nodes to the data aggregating apparatus 203. Further, the first obtaining unit 701 may obtain a hop count that is largest among hop counts for a signal transmitted from the user terminal 201 to be transferred by multihop communication among the nodes to the data aggregating apparatus 203. Further, the first obtaining unit 701 may obtain as the hop count, an average value of or a largest value of hop counts obtained for plural signal transmissions from the user terminal 201. The obtained data is stored to a storage area of the RAM 303, the large capacity non-volatile memory 304, etc.

The calculating unit 702 calculates based on a communication time of communication between the nodes in the network 205 and the hop count obtained by the first obtaining unit 701, a collection time consumed for sensor data collection. Calculation of the time is represented by equation (1) described hereinafter.

The calculating unit 702 calculates for each integer from 0 to the hop count, the communication time for sensor data of a cumulative count of the integers, based on a prescribed size of sensor data of the cumulative count of the integers and the communication time per unit data between the nodes of the network 205. The calculating unit 702 may cumulate the communication time of the sensor data of the cumulative count of the integers, calculated for each integer from 0 to the hop count to thereby, calculate the collection time consumed for sensor data collection. Calculation of the time is represented by equations (2) to (4) described hereinafter. The calculated collection time is stored to a storage area of the RAM 303, the large capacity non-volatile memory 304, etc.

The first determining unit 703 determines whether reception information has been received from the data aggregating apparatus 203 before the collection time, which is from the transmission of the data collection request by the first transmitting unit 704 and calculated by the calculating unit 702, elapses. Further, the first determining unit 703 is assumed to be a function of the user terminal 201 and the first transmitting unit 704 is assumed to be a function of the data collection requesting apparatus 202. In this case, the first determining unit 703 may regard the time point when the first transmitting unit 704 transmitted the data collection request to be the time point when the user terminal 201 transmitted instruction of a data collection request to the data collection requesting apparatus 202. Further, in this case, the first determining unit 703 may add to the collection time, the time consumed for instruction of the data collection request. Determination results are stored to a storage area of the RAM 303, the large capacity non-volatile memory 304, etc.

The first transmitting unit 704 transmits a sensor data collection request to the network 205. The first transmitting unit 704 transmits the data collection request to the network 205 when the first determining unit 703 determines that reception information has not been received before the collection time has elapsed since the transmission of the data collection request.

When sensor data that has been transferred by multihop communication among the nodes of the network 205 in response to the data collection request has been received, the second determining unit 711 determines if a count of received sensor data is a given count or greater. Determination results are stored to a storage area of the RAM 503, the large capacity non-volatile memory 504, etc.

Here, a given count is a value based on a count of the nodes in the network 205. The given count is a value preset by the user of the sensor network system 200. For example, the given count, in the simplest example, is the same number as the number of nodes in the network 205. Further, for example, the given count may be about 10 percent less than the installed number of nodes when the nodes have been installed in an excess of 10 percent to take redundancy into consideration.

The second transmitting unit 712 transmits the reception information to the user terminal 201 via the network 204, when sensor data that has been transferred by multihop communication among the nodes of the network 205 has been received in response to the data collection request. The reception information is information indicating that sensor data corresponding to the data collection request has been received. For example, the reception information may be an identifier indicating that sensor data corresponding to the data collection request has been received, the sensor data itself, etc.

Further, the second transmitting unit 712 may transmit the reception information to the user terminal 201 via the network 204, when the second determining unit 711 determines that the count of sensor data is a given count or greater.

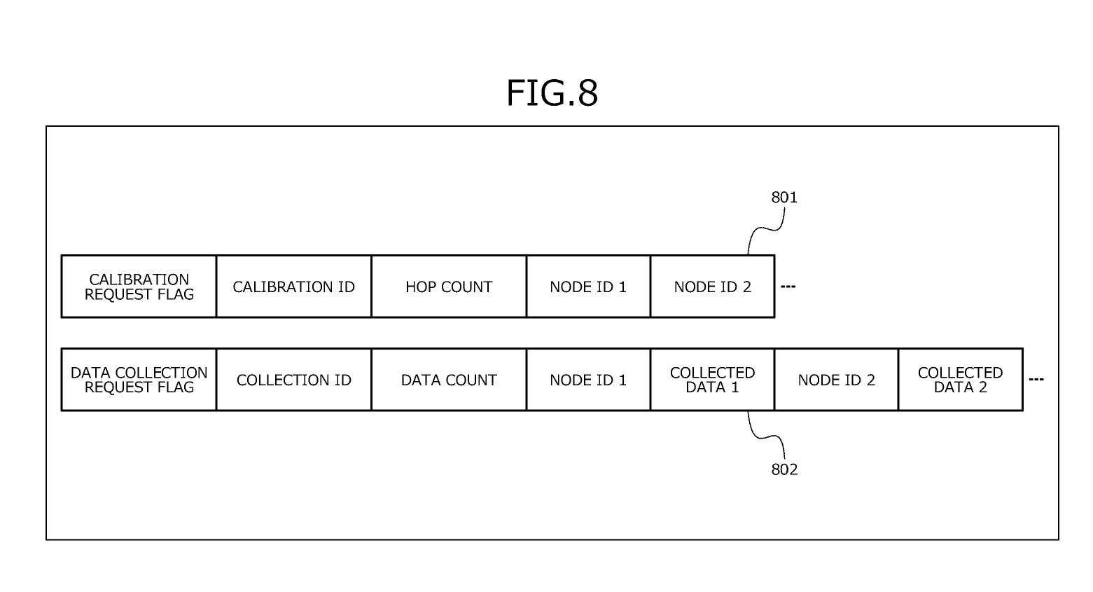

FIG. 8 is a diagram depicting an example of packet formats. In FIG. 8, as packets according to the present embodiment, there are two types including a packet indicating calibration request and a packet indicating data collection request. Hereinafter, a packet indicating calibration request will be called a “calibration request packet”. A packet indicating data collection request will be called a “data collection request packet”.

The calibration request packet follows a packet format 801. The packet format 801 has sequentially from the head, fields for a calibration request flag, a calibration ID, a hop count, a node ID1, a node ID2, . . . . The node IDs are equivalent in number to the value stored in the hop count field.

The calibration request flag field stores a value indicating that the packet is a calibration request packet. The calibration ID field is to prevent confusion with past calibration requests at the data aggregating apparatus 203, when calibration is performed plural times. The calibration ID field stores a unique value by the user terminal 201 or the data collection requesting apparatus 202. The hop count field stores 0 at the stage where the data collection requesting apparatus 202 transmits the packet, and stores a value that increases by 1 each time the packet passes a node. Subsequent to the hop count field, node ID fields that store the IDs of nodes through which the packet passes are added accordingly.

The data collection request packet follows a packet format 802. The packet format 802 has sequentially from the head, fields for a data collection request flag, a collection ID, a data count, a node ID1, collected data 1, node ID2, collected data 2, . . . . The node ID and the collected data are equivalent in number to the value stored in the data count field.

The data collection request flag field stores a value indicating that the packet is a data collection request. The collection ID field stores a unique value used to prevent confusion with the previous collection. The data count field stores a count of sets when the collected data and node ID appended to the packet are regarded as 1 set. For example, at the stage where the data collection requesting apparatus 202 transmits the packet, the data count field stores 0 since there is no collected data. The data count field may store subsequent to the data count, a sensor node ID and the size of the collected data. Subsequent to the data count field, node ID fields that store the IDs of nodes through which the packet passes and collected data fields that store the data obtained from the sensor 602 of the node through which the packet passes are added accordingly. The size of the collected data field is a predetermined prescribed size.

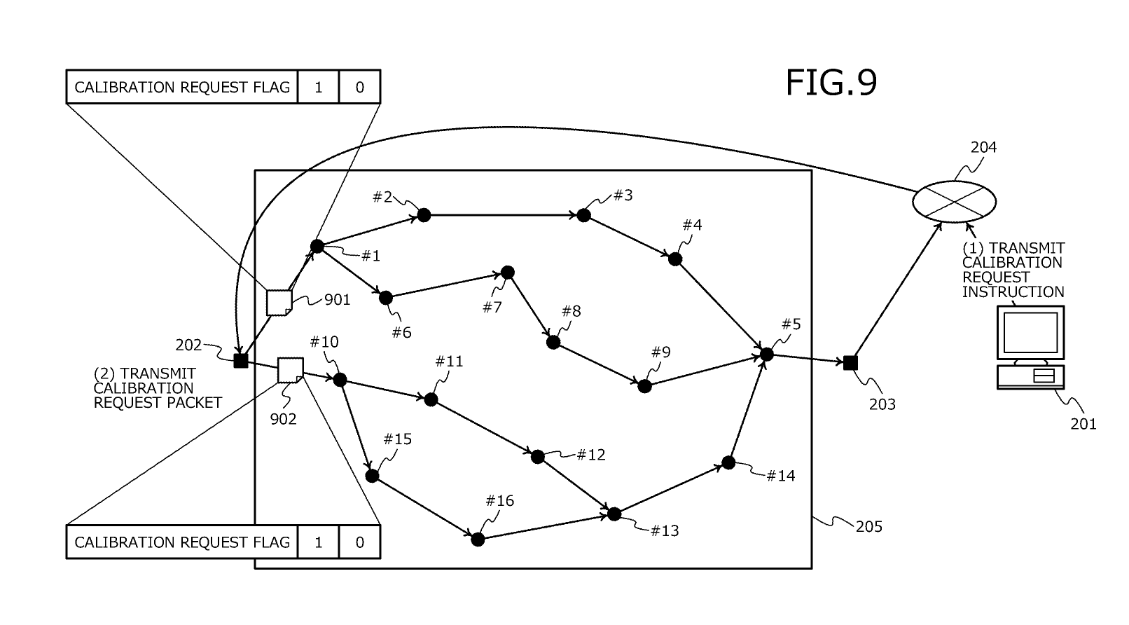

An operation example in a case when a calibration request packet is relayed in the sensor network system 200 will be described with reference to FIGS. 9 to 11.

FIG. 9 is a diagram (part 1) of an operation example at the time of calibration request transmission. As indicated by (1) in FIG. 9, the user terminal 201 transmits a calibration request instruction to the data collection requesting apparatus 202.

As indicated by (2) in FIG. 9, the data collection requesting apparatus 202, which has received the calibration request instruction, transmits a calibration request packet to nearby nodes: node #1 and node #10. In FIG. 9, calibration request packets 901, 902 transmitted by the data collection requesting apparatus 202, for example, store “1” in the calibration ID field and store “0” in the hop count field.

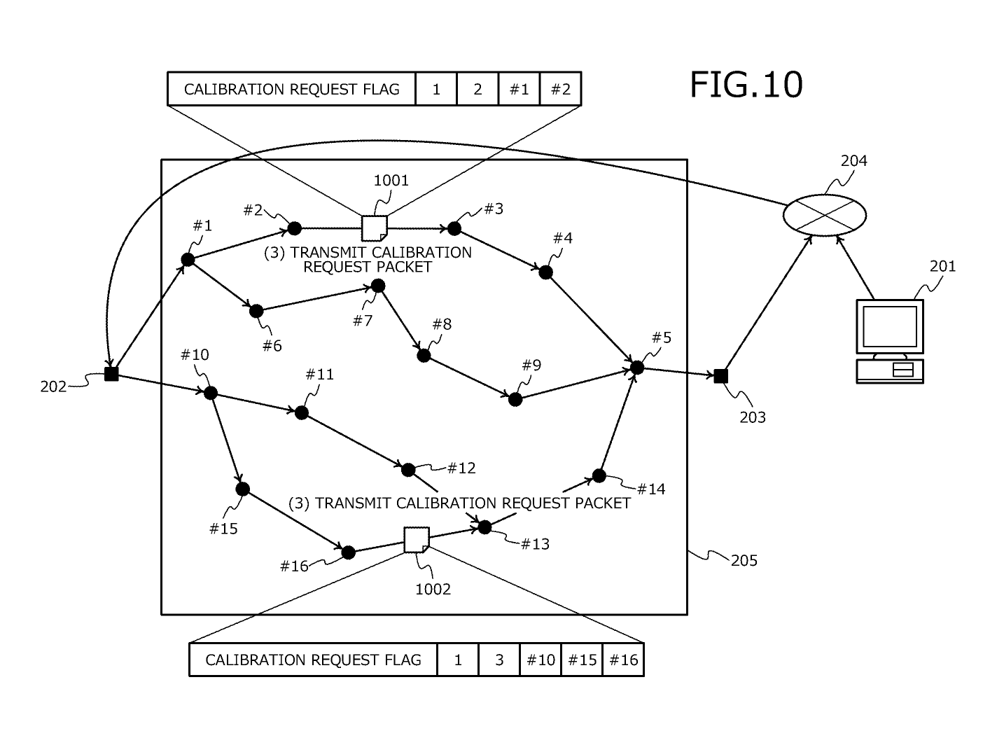

FIG. 10 is a diagram (part 2) of the operation example at the time of calibration request transmission. FIG. 10 depicts relaying of the calibration request packet among the nodes.

A node that has received a packet refers to the head field and determines whether the received packet is a calibration request packet or a data collection request packet. If the received packet is a calibration request packet, the node obtains the node IDs from the received packed and determines whether the node ID thereof is included.

Inclusion of the node ID thereof indicates that the packet was transmitted by the node thereof and has returned by a looping of the node path. Therefore, the node discards the received packet. If the node ID thereof is not included, the node increases the hop count of the received packet by 1 and stores the node ID thereof in a new node ID field. As indicated by (3) in FIG. 10, to nearby nodes, the node transmits the packet in which the node ID thereof is stored.

In the example depicted in FIG. 10, node #2 transmits a calibration request packet 1001 to node #3, which is a nearby node. The calibration request packet 1001 has 2 node ID fields. The respective node ID fields of the calibration request packet 1001 store “#1” and “#2”, respectively. Furthermore, node #16 transmits a calibration request packet 1002 to node #13, which is a nearby node. The calibration request packet 1002 has 3 node ID fields. The respective node ID fields of the calibration request packet 1002 store “#10”, “#15”, and “#16”, respectively.

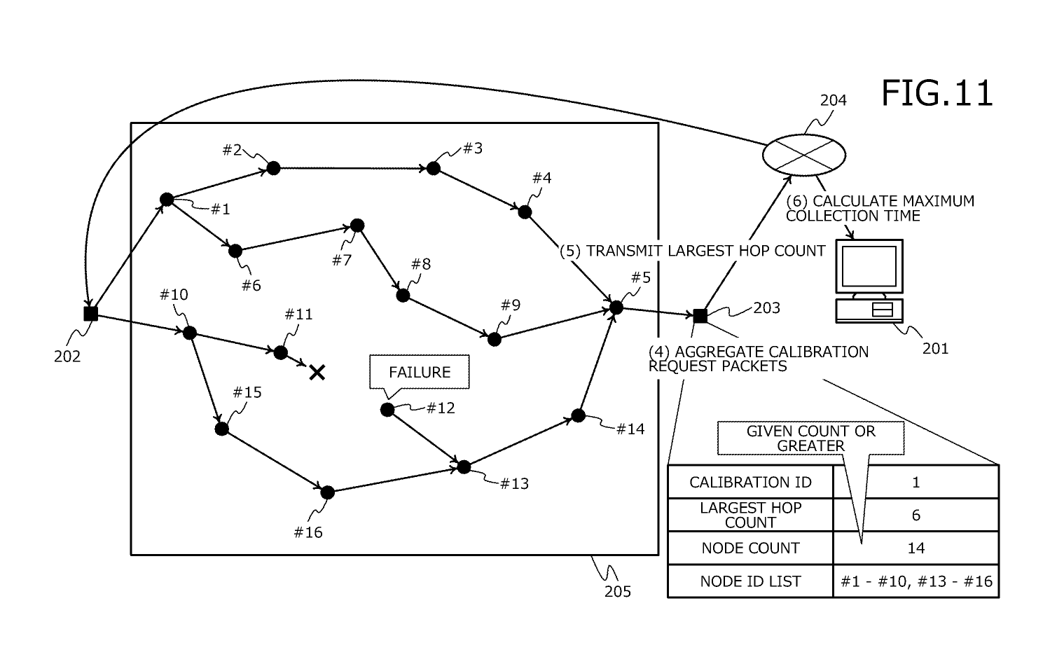

FIG. 11 is a diagram (part 3) of the operation example at the time of calibration request transmission. FIG. 11 depicts a result of relaying the calibration request packet among the nodes. Furthermore, in FIG. 11, it is assumed that node #12 has failed and the calibration request packet transmitted by node #11 could not be relayed. As indicated by (4) in FIG. 11, the data aggregating apparatus 203 aggregates and stores to the large capacity non-volatile memory 504, received calibration request packets. Description concerning an aggregation procedure is given next.

When a packet is received, the data aggregating apparatus 203 refers to the head field and determines whether the received packet is a calibration request packet or a data collection request packet. If the received packet is a calibration request packet, the data aggregating apparatus 203 obtains the hop count of the received packet and compares the obtained hop count with the largest hop count currently stored. If the obtained hop count is greater than the largest hop count, the data aggregating apparatus 203 updates the largest hop count to the obtained hop count. Further, the data aggregating apparatus 203 stores as a currently stored ID, an ID that among the node IDs stored in the node ID fields of the received packet is not registered as a currently stored ID.

As storage contents of the large capacity non-volatile memory 504, the data aggregating apparatus 203 stores concerning calibration ID “1”, a largest hop count “6”, a node count “14”, and a node ID list “#1 to #10, #13 to #16”. In the example depicted in FIG. 11, paths for which the hop count is “6” include a path of “#1”, “#6”, “#7”, “#8”, “#9”, “#5” and a path of “#10”, “#15”, “#16”, “#13”, “#14”, “#5”.

After storing the node IDs, the data aggregating apparatus 203 depicted in FIG. 11 determines if the number of stored node IDs is a given count or greater. If the number of stored node IDs is the given count or greater, as indicated by (5) in FIG. 11, the data aggregating apparatus 203 transmits the largest hop count to the user terminal 201, via the network 204.

As indicated by (6) in FIG. 11, the user terminal 201, which has received the largest hop count, uses the largest hop count to calculate the maximum collection time. For example, the user terminal 201 uses equation (1) to calculate a maximum collection time Wₘₐₓ.

Wₘₐₓ=Hₘₐₓ×Tₐᵥₑ (1)

Where, Hₘₐₓ is the largest hop count and Tₐᵥₑ is the average communication time between nodes. In equation (1), Tₐᵥₑ is value obtained by measurement in advance.

Further, the user terminal 201 may use equation (2) to calculate the maximum collection time Wₘₐₓ.

Wₘₐₓ=T_{H}×Hₘₐₓ+Σᵢ₌₀^{H}^{ₘₐₓ}T_{D}×i (2)

Where, T_{H} is calculated using equation (3).

T_{H}=T_{O}+D_{H}×P (3)

T_{D} is calculated using equation (4).

T_{D}=D_{D}×P (4)

Where, T_{O} is the communication processing time at a node and D_{H} is the data volume of a header portion of a packet. Here, in the packet format 801, the header portion includes the fields for the calibration request flag, the calibration ID, and the hop count. Further, in the packet format 802, the header portion includes fields for the data collection request flag, the collection ID, and the data count. D_{D} is a prescribed data volume of a packet data portion for 1 hop. Here, in the packet format 801, the data portion includes the fields for the node IDs. Further, in the packet format 802, the data portion includes the fields for the node IDs and the collected data. P is the communication time per unit data.

In equations (2) to (4), T_{O}, D_{H}, D_{D}, and P are values determined by, for example, the type of data to be collected, the design communication speed and processing speed of the nodes. Therefore, when Wₘₐₓ is calculated, variables other than Hₘₐₓ may be treated as fixed values.

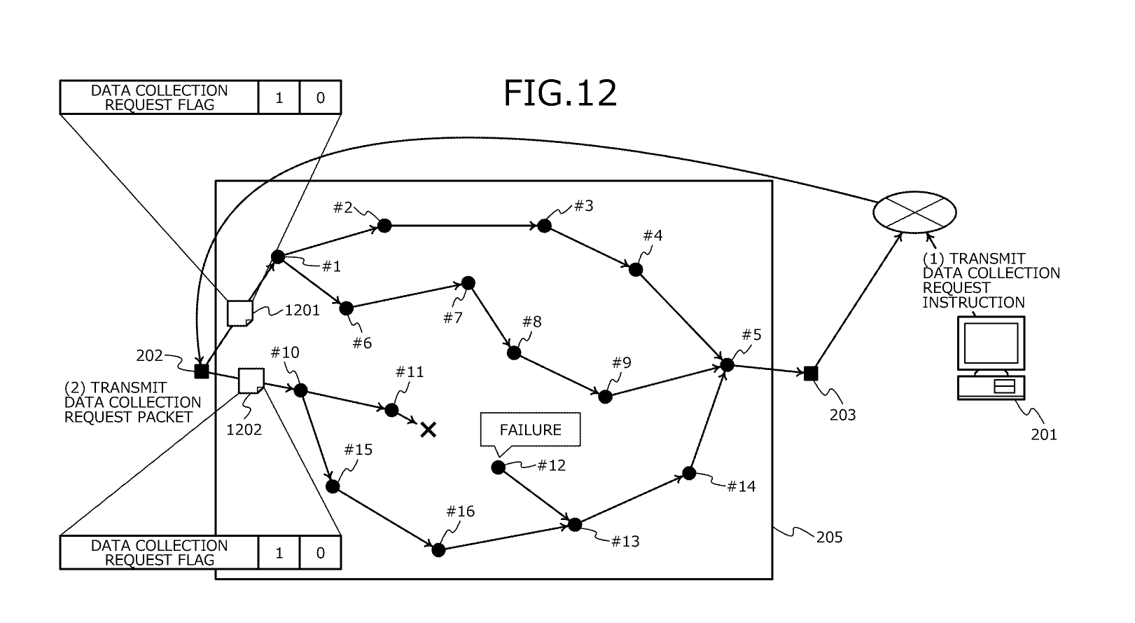

An operation example in a case where a data collection request packet is relayed in the sensor network system 200 will be described with reference to FIGS. 12 to 15.

FIG. 12 is a diagram (part 1) of an operation example at the time of data collection request transmission. As indicated by (1) in FIG. 12, the user terminal 201 transmits a data collection request instruction to the data collection requesting apparatus 202. After transmitting the data collection request instruction, the user terminal 201 waits for reception of data that corresponds to the data collection request instruction from the data aggregating apparatus 203, until the maximum collection time elapses.

As indicated by (2) in FIG. 12, the data collection requesting apparatus 202, which has received the data collection request instruction, transmits a data collection request packet to nearby nodes: node #1 and node #10. In FIG. 12, data collection request packets 1201, 1202 transmitted by the data collection requesting apparatus 202, for example, store “1” in the collection ID field and store “0” in the data count field.

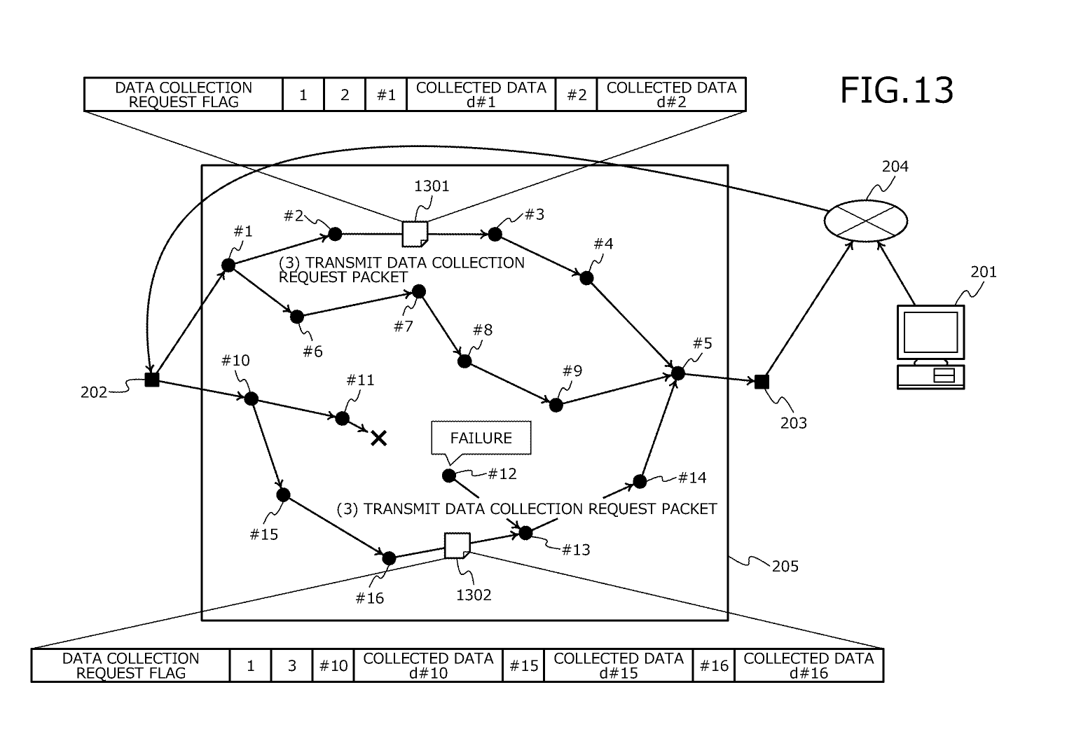

FIG. 13 is a diagram (part 2) of the operation example at the time of data collection request transmission. FIG. 13 depicts relaying of the data collection request packet among the nodes.

A node that has received a packet refers to the head field and determines whether the received packet is a calibration request packet or a data collection request packet. If the received packet is a data collection request packet, the node obtains the node IDs from the received packet and determines whether the node ID thereof is included.

Inclusion of the node ID thereof indicates that the packet was transmitted by the node thereof and has received by a looping of the node path. Therefore, the node discards the received packet. If the node ID thereof is not included, the node increases the data count of the received packet by 1 and stores the node ID thereof and measurement data from the sensor 602 thereof to a new node ID field and collected data field. As indicated by (3) in FIG. 13, to nearby nodes, the node transmits the packet to which the node ID and measurement data thereof have been stored.

In the example depicted in FIG. 13, node #2 transmits a data collection request packet 1301 to node #3, which is a nearby node. The data collection request packet 1301 has 2 node ID fields and collected data fields. The respective node ID fields of the data collection request packet 1301 store “#1” and “#2”, respectively. Further, the respective collected data fields of the data collection request packet 1301 store “collected data d#1” and “collected data d#2”, respectively.

Node #16 transmits a data collection request packet 1302 to node #13, which is a nearby node. The data collection request packet 1302 has 3 node ID fields and 3 collected data fields. The respective node ID fields of the data collection request packet 1302 stores “#10”, “#15”, and “#16”, respectively. Further, the respective collected data fields of the data collection request packet 1302 store “collected data d#10”, “collected data d#15”, and “collected data d#16”, respectively.

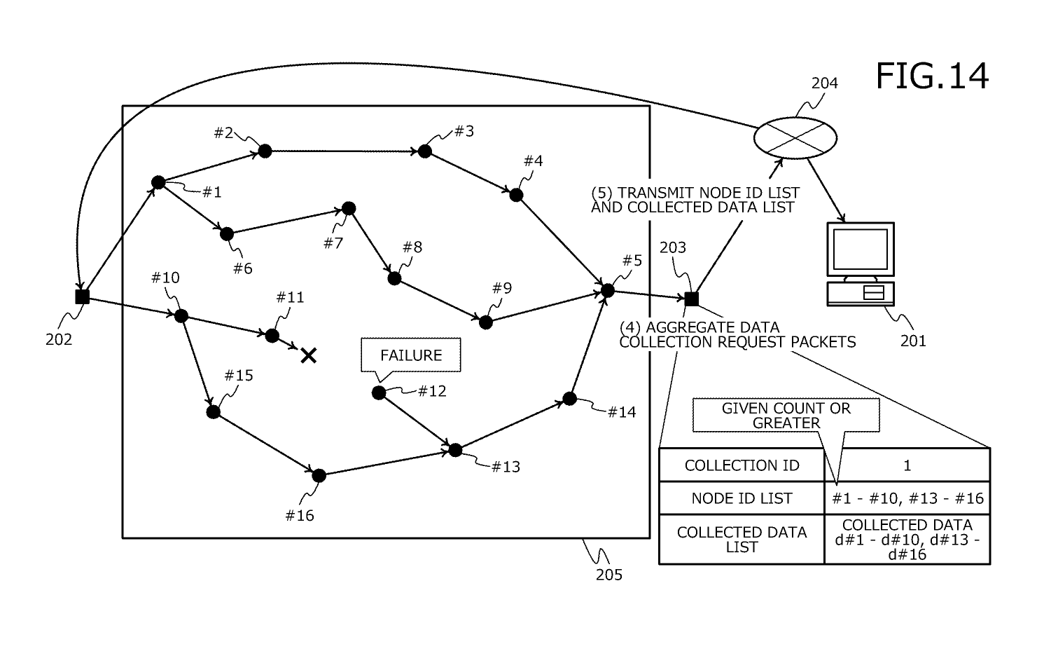

FIG. 14 is a diagram (part 3) of the operation example at the time of data collection request transmission. FIG. 14 depicts results of relaying the data collection request packet among the nodes. Furthermore, in FIG. 14, it is assumed that node #12 has failed and the data collection request packet transmitted by node #11 could not be relayed. As indicated by (4) in FIG. 14, the data aggregating apparatus 203 aggregates and stores to the large capacity non-volatile memory 504, received data collection request packets. Description concerning an aggregation procedure is given next.

When a packet is received, the data aggregating apparatus 203 refers to the head field and determines whether the received packet is a calibration request packet or a data collection request packet. If the received packet is a data collection request packet, the data aggregating apparatus 203 stores as a currently stored ID, an ID that among the node IDs stored in the node ID fields of the received packet is not registered as a currently stored ID. The data aggregating apparatus 203 further stores the collected data that corresponds to the unregistered IDs.

As stored contents of the large capacity non-volatile memory 504, the data aggregating apparatus 203 stores concerning collection ID “1”, a node ID list “#1 to #10, #13 to #16” and a collected data list “collected data d#1 to d#10, d#13 to d#16”.

The data aggregating apparatus 203 determines if the number of registered IDs is a given count or greater. If the number of registered IDs is the given count or greater, as indicated by (5) in FIG. 14, the data aggregating apparatus 203 transmits as reception information, the node ID list and the collected data list to the user terminal 201.

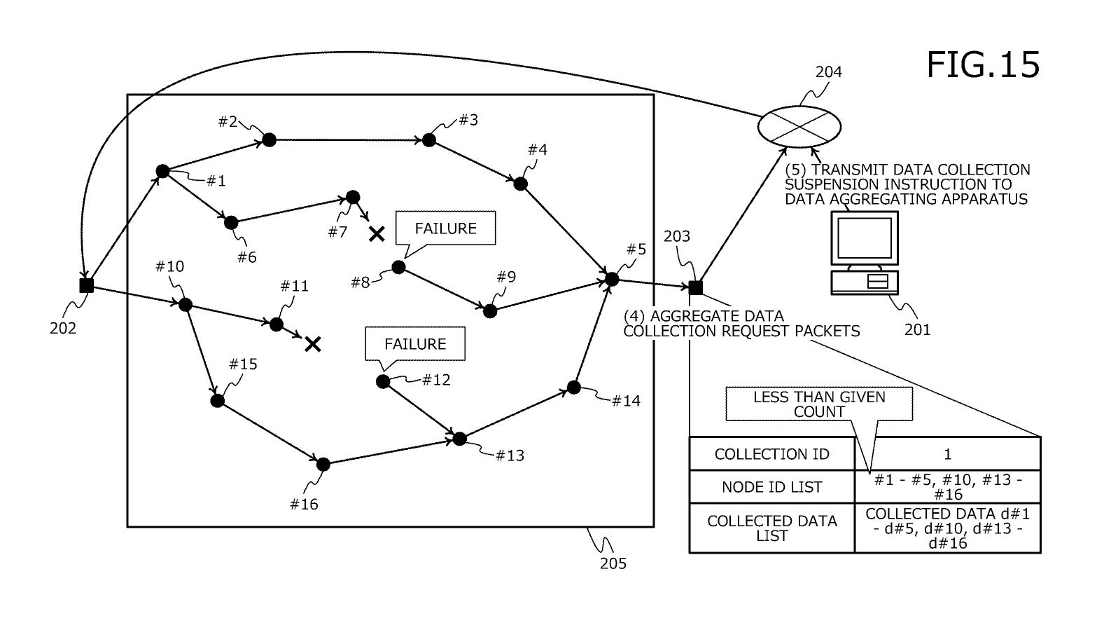

FIG. 15 is a diagram (part 4) of the operation example at the time of data collection request transmission. FIG. 15 depicts a result of relaying the data collection request packet among the nodes. Further, in FIG. 15, it is assumed that nodes #8, #12 have failed and the data collection request packets transmitted by nodes #6, #7, #11 could not be relayed. Further, it is assumed that no data collection request packet reaches node #9. As indicated by (4) in FIG. 15, the data aggregating apparatus 203 aggregates and stored to the large capacity non-volatile memory 504, received data collection request packets.

The data aggregating apparatus 203 determines if the number of registered IDs is a given count or greater. If the number of registered IDs is less than the given count, the data aggregating apparatus 203 does not transmit the node ID or the collected data list to the user terminal 201.

Further, the maximum collection time is assumed to have elapsed since the transmission of the data collection request packet. Here, as indicated by (5) in FIG. 15, the user terminal 201 transmits a data collection suspension instruction to the data aggregating apparatus 203. The data aggregating apparatus 203, which has received the data collection suspension instruction, suspends the process of aggregating data collection request packets.

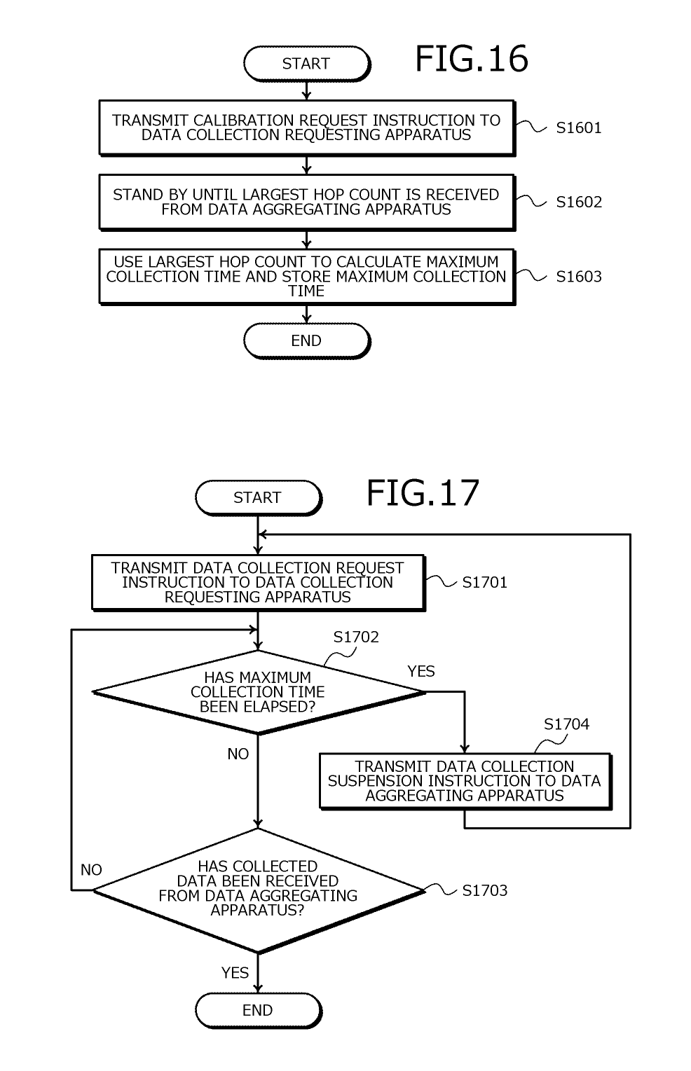

Flowcharts of the sensor network system 200 according to the first embodiment will be depicted using FIGS. 16 to 28.

FIG. 16 is a flowchart of one example of a procedure of a calibration request instructing process by the user terminal according to the first embodiment. The calibration request instructing process by the user terminal according to the first embodiment is a process of instructing a calibration request with respect to the sensor network system 200.

The user terminal 201 transmits a calibration request instruction to the data collection requesting apparatus 202 (step S1601). The user terminal 201 stands by until the largest hop count is received from the data aggregating apparatus 203 (step S1602). When the largest hop count has been received, the user terminal 201 uses the largest hop count to calculate the maximum collection time and stores the maximum collection time to the large capacity non-volatile memory 304 (step S1603). A calculation example of the collection time will be described with reference to FIG. 11.

After completing the operations at step S1603, the user terminal 201 ends the calibration request instructing process by the user terminal according to the first embodiment. By executing the calibration request instructing process by the user terminal according to the first embodiment, the user terminal 201 is able to set an optimal time elapsing until data that corresponds to a data collection request is received.

FIG. 17 is a flowchart of one example of a procedure of a data collection request instructing process by the user terminal. The data collection request instructing process by the user terminal is a process of instructing a data collection request with respect to the sensor network system 200.

The user terminal 201 transmits a data collection request instruction to the data collection requesting apparatus 202 (step S1701). The user terminal 201, after transmitting the data collection request, determines whether the maximum collection time has elapsed (step S1702). If the maximum collection time has not elapsed (step S1702: NO), the user terminal 201 determines whether collected data has been received from the data aggregating apparatus 203 (step S1703). If collected data has been received (step S1703: YES), the user terminal 201 ends the data collection request instructing process by the user terminal. If collected data has not been received (step S1703: NO), the user terminal 201 transitions to the operation at step S1702.

If the maximum collection time has elapsed (step S1702: YES), the user terminal 201 transmits a data collection suspension instruction to the data aggregating apparatus 203 (step S1704). By executing the data collection request instructing process by the user terminal, the user terminal 201 is able to collect data of the sensor network system 200.

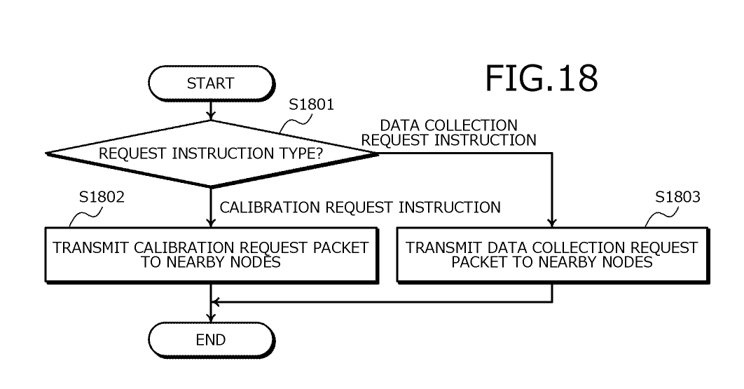

FIG. 18 is a flowchart of one example of a procedure of a request instructing process by the data collection requesting apparatus. The request instructing process by the data collection requesting apparatus is a process of executing a process according to the type of request instruction received. Further, the request instructing process is executed when the request instruction transmitted at step S1601 or step S1701 is received.

The data collection requesting apparatus 202 determines whether the type of the request instruction matches any of the following (step S1801). Types of the request instruction include a calibration request instruction and a data collection request instruction. When the type of the request instruction is a calibration request (step S1801: calibration request instruction), the data collection requesting apparatus 202 transmits a calibration request packet to nearby nodes (step S1802).

When the type of the request instruction is a data collection request instruction (step S1801: data collection request instruction), the data collection requesting apparatus 202 transmits a data collection request packet to nearby nodes (step S1803). After completing the operation at step S1802 or step S1803, the data collection requesting apparatus 202 ends the request instructing process by the data collection requesting apparatus. By executing the request instructing process by the data collection requesting apparatus, the data collection requesting apparatus 202 is able to determine the type of request instruction and execute a process according to the type of request instruction.

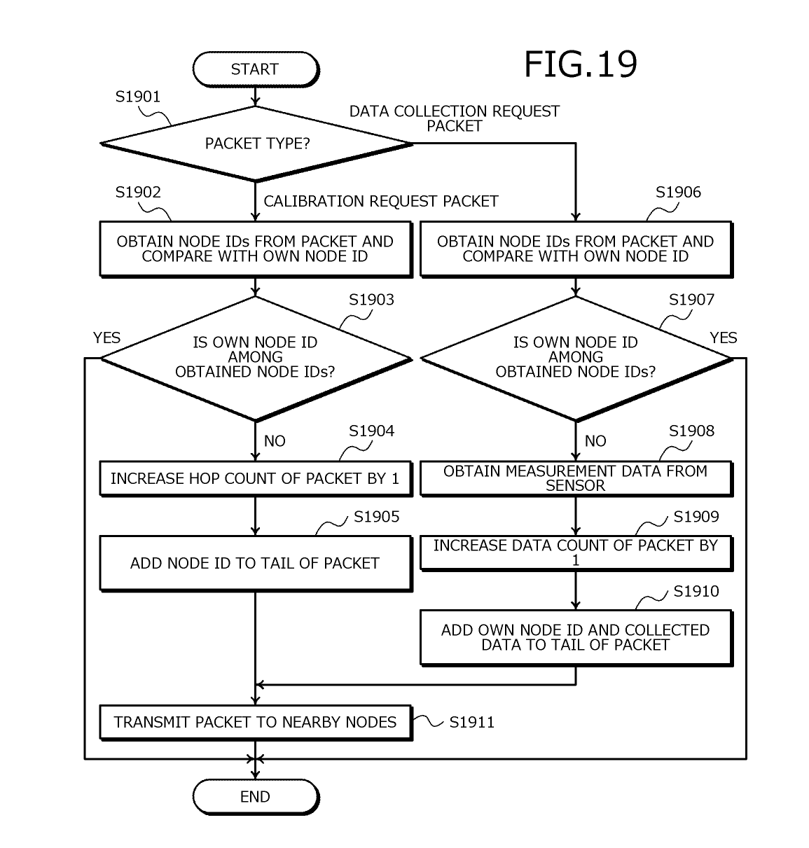

FIG. 19 is a flowchart of one example of a procedure of a packet process by a node. The packet process by a node is a process of executing a process according to the type of the packet received. Further, a packet receiving process is executed when the packet transmitted at step S1802, step S1803, or step S1911 is received. In the description of FIG. 19, a case where the execution agent is node #1 will be described as an example.

Node #1 determines whether the packet type matches any one of the following (step S1901). Packet types include a calibration request packet and a data collection request packet.

If the packet type is a calibration request packet (step S1901: calibration request packet), node #1 obtains node IDs from the packet and compares the obtained node IDs with the node ID of node #1 (step S1902). Node #1 determines whether the node ID of node #1 is among the obtained node IDs (step S1903). If the node ID of node #1 is not present (step S1903: NO), node #1 increases the hop count of the packet by 1 (step S1904). Node #1 adds the node ID thereof to the tail of the packet (step S1905).

On the other hand, if the packet type is a data collection request packet (step S1901: data collection request packet), node #1 obtains node IDs from the packet and compares the obtained node IDs with the node ID of node #1 (step S1906). Node #1 determines whether the node ID of node #1 is among the obtained node IDs (step S1907). If the node ID thereof is not present (step S1907: NO), node #1 obtains measurement data from the sensor 602 (step S1908). Node #1 increases the data count of the packet by (step S1909). Node #1 adds the node ID and collected data of node #1 to the tail of the packet (step S1910).

After completing the operation at step S1905 or step S1910, node #1 transmits the packet to nearby nodes (step S1911). After completing the operation at step S1911 or if the node ID of node #1 is among the obtained node IDs (step S1903: YES, step S1907: YES), node #1 ends the packet process by a node. By executing the packet process by a node, node #1 is able to execute a process according to the type of the packet received.

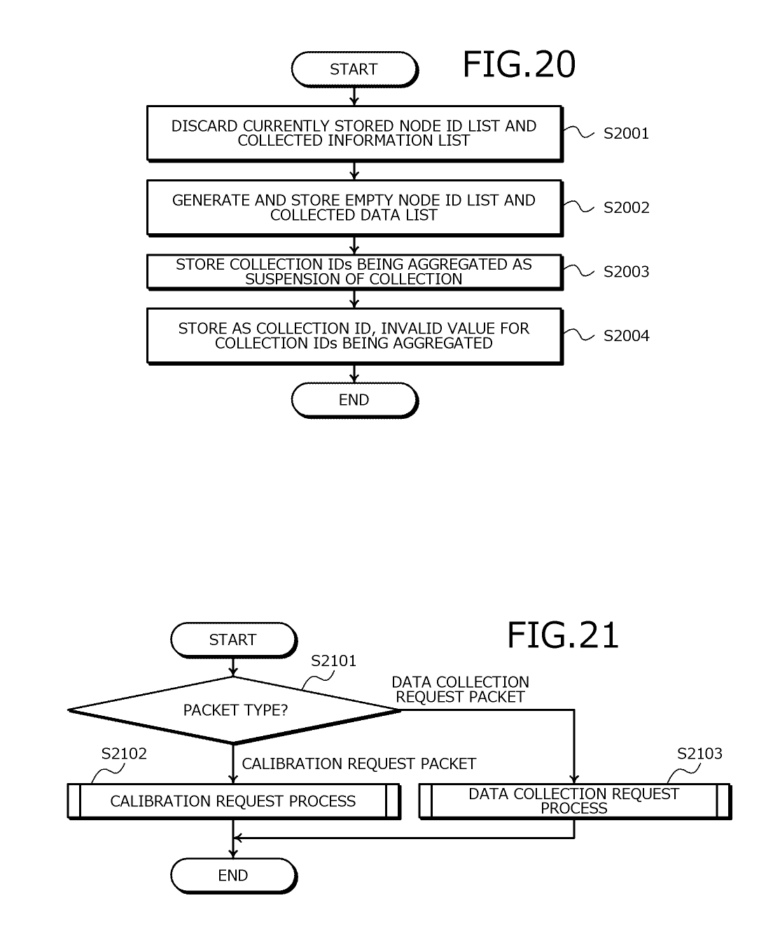

FIG. 20 is a flowchart of one example of a procedure of a data collection suspension instruction receiving process by the data aggregating apparatus. The data collection suspension instruction receiving process by the data aggregating apparatus is a process executed when a data collection suspension instruction is received from the user terminal 201. Further, the data collection suspension instruction receiving process is executed when the data collection suspension instruction is received consequent to step S1704.

The data aggregating apparatus 203 discards the currently stored node ID list and collected information list (step S2001). The data aggregating apparatus 203 generates and stores an empty node ID list and collected data list (step S2002). The data aggregating apparatus 203 stores the collection IDs being aggregated as suspension of the collection thereof (step S2003). The data aggregating apparatus 203 stores as a collection ID, an invalid value for the collection IDs being aggregated (step S2004).

Here, an invalid value is a value that is not used as a calibration ID or collection ID. For example, a designer of the sensor network system 200 sets a specific value such as 0, 0xFFFF, etc. as an invalid value in advance at the time of system design.

After completing the operation at step S2004, the data aggregating apparatus 203 ends the data collection suspension instruction receiving process by the data aggregating apparatus. By executing the data collection suspension instruction receiving process by the data aggregating apparatus, the data aggregating apparatus 203 is able to suspend data collection.

FIG. 21 is a flowchart of one example of a procedure of a packet receiving process by the data aggregating apparatus. The packet receiving process by the data aggregating apparatus is a process of executing a process according to the type of packet received. Further, the packet receiving process is executed when the packet transmitted at step S1911 is received.

The data aggregating apparatus 203 determines whether the packet type matches any one of the following (step S2101). Packet types include a calibration request packet and a data collection request packet.

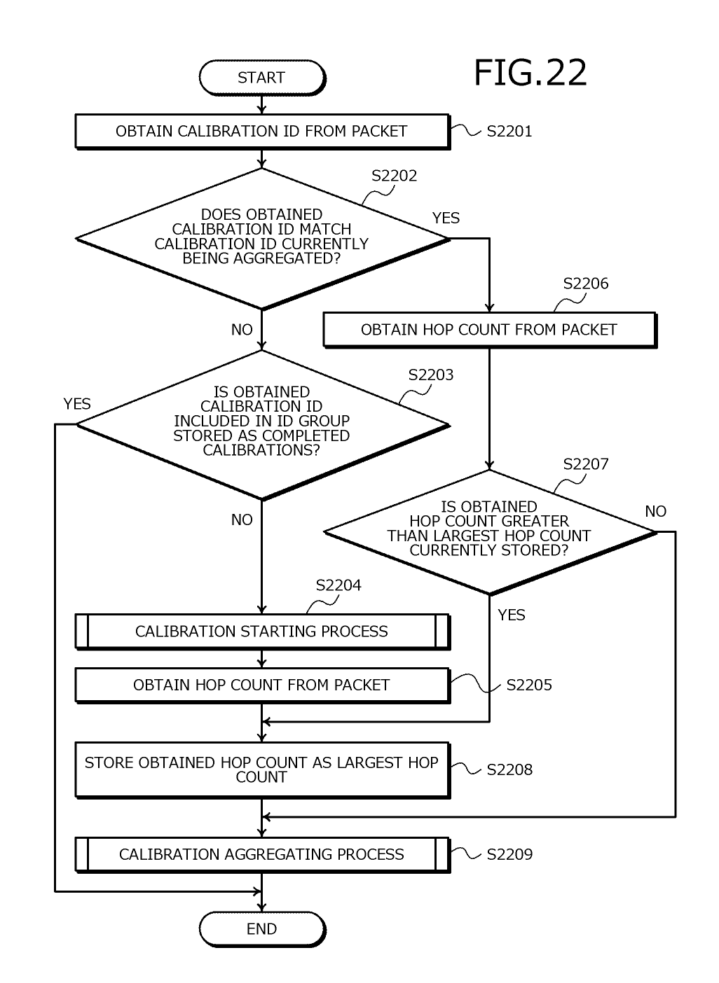

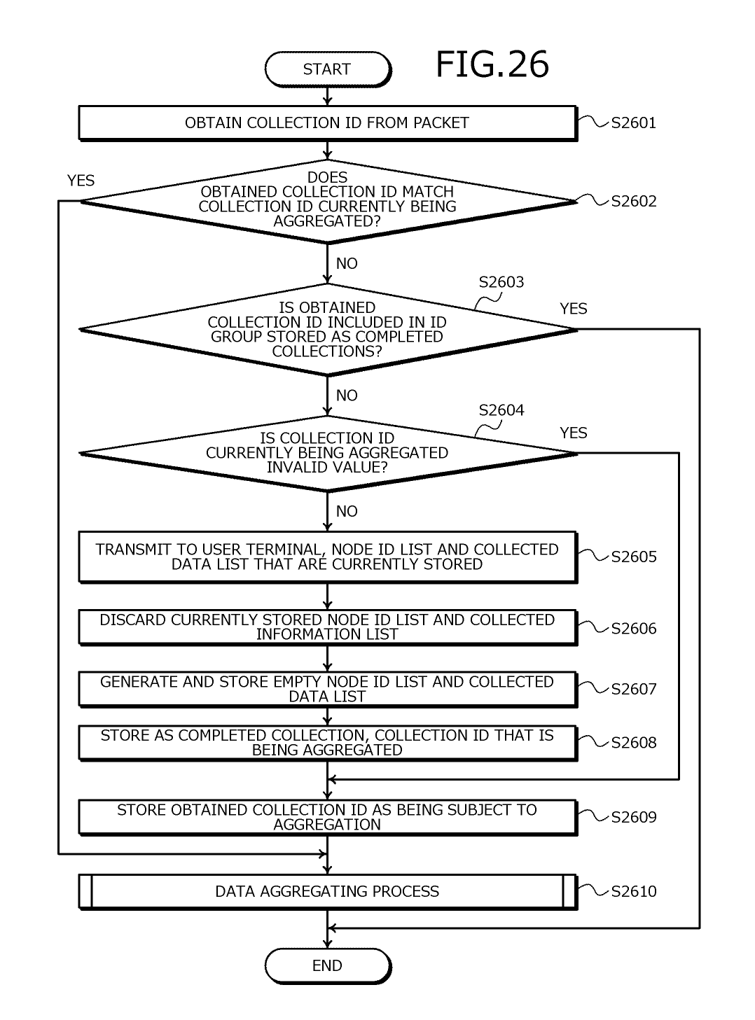

If the packet type is a calibration request packet (step S2101: calibration request packet), the data aggregating apparatus 203 executes a calibration request process (step S2102). Details of the calibration request process will be described hereinafter with reference to FIG. 22. On the other hand, if the packet type is a data collection request packet (step S2101: data collection request packet), the data aggregating apparatus 203 executes a data collection request process (step S2103). Details of the data collection request process will be described hereinafter with reference to FIG. 26.

After completing the operations at step S2102 or at step S2103, the data aggregating apparatus 203 ends the packet receiving process by the data aggregating apparatus. By executing the packet receiving process by the data aggregating apparatus, the data aggregating apparatus 203 is able to determine the packet type and execute a process according to the packet type.

FIG. 22 is a flowchart of one example of a procedure of the calibration request process by the data aggregating apparatus. The calibration request process by the data aggregating apparatus is a process performed when a calibration request packet has been received.

The data aggregating apparatus 203 obtains the calibration ID from the packet (step S2201). The data aggregating apparatus 203 determines whether the obtained calibration ID matches the calibration ID currently being aggregated (step S2202). If the obtained calibration ID does not match the calibration ID currently being aggregated (step S2202: NO), the data aggregating apparatus 203 determines whether the obtained calibration ID is included in an ID group stored as completed calibrations (step S2203).

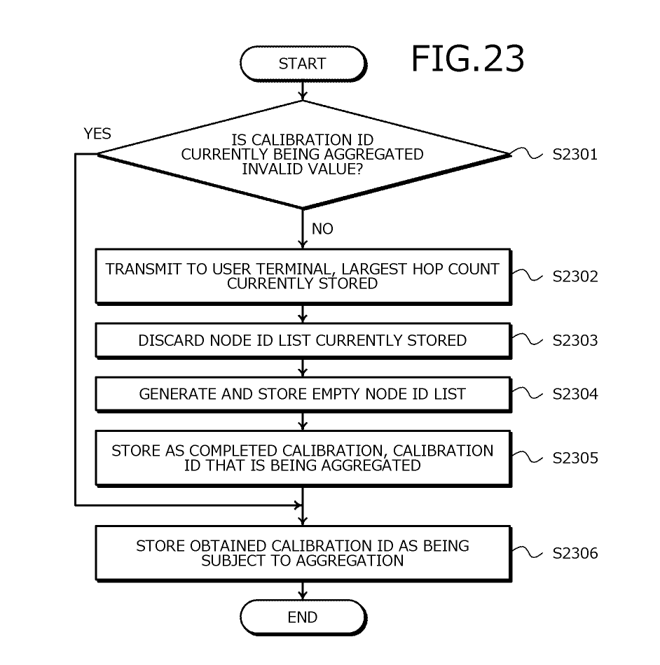

If the obtained calibration ID is not included in the ID group stored as completed calibrations (step S2203: NO), the data aggregating apparatus 203 executes a calibration starting process (step S2204). Details of the calibration starting process will be described hereinafter with reference to FIG. 23. The data aggregating apparatus 203 obtains the hop count from the packet (step S2205).

If the obtained calibration ID matches the calibration ID currently being aggregated (step S2202: YES), the data aggregating apparatus 203 obtains the hop count from the packet (step S2206). The data aggregating apparatus 203 determines whether the obtained hop count is greater than the largest hop count currently stored (step S2207).

After completing the operation at step S2205 or if the obtained hop count is greater than the largest hop count currently stored (step S2207: YES), the data aggregating apparatus 203 stores the obtained hop count as the largest hop count (step S2208).

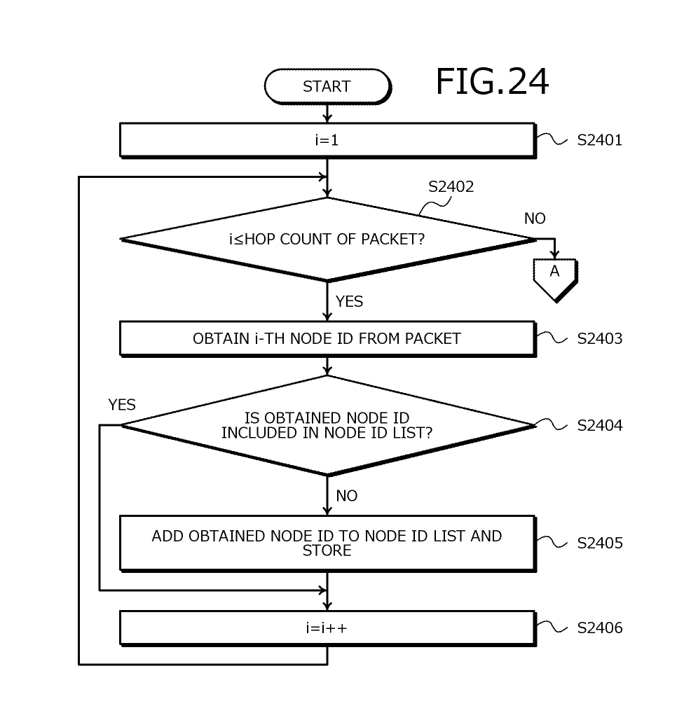

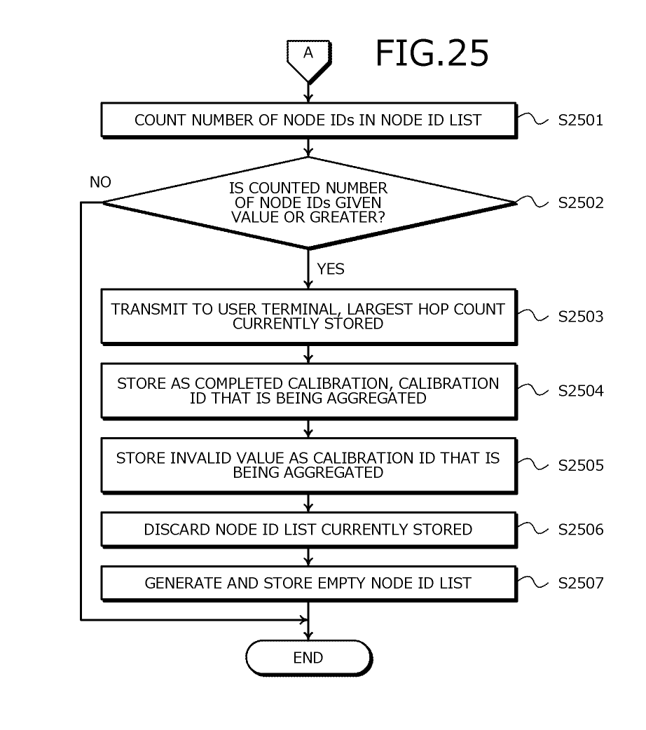

After completing the operation at step S2208 or if the obtained hop count is the largest hop count currently stored or less (step S2207: NO), the data aggregating apparatus 203 executes a calibration aggregating process (step S2209). Details of the calibration aggregating process will be described hereinafter with reference to FIGS. 24 and 25.

After completing the operations at step S2209 or if the obtained calibration ID is included in the ID group stored as completed calibrations (step S2203: YES), the data aggregating apparatus 203 ends the calibration request process by the data aggregating apparatus. By executing the calibration request process by the data aggregating apparatus, the data aggregating apparatus 203 is able to process a calibration request packet.

FIG. 23 is a flowchart of one example of a procedure of the calibration starting process by the data aggregating apparatus. The calibration starting process by the data aggregating apparatus is a process of starting aggregation of calibration request packets.

The data aggregating apparatus 203 determines whether the calibration ID currently being aggregated is an invalid value (step S2301). If the calibration ID currently being aggregated is not an invalid value (step S2301: NO), the data aggregating apparatus 203 transmits to the user terminal 201, the largest hop count currently stored (step S2302). The case of step S2301: NO occurs when the user terminal 201 has re-sent the calibration request packet.

After completing the operation at step S2302, the data aggregating apparatus 203 discards the node ID list currently stored (step S2303). The data aggregating apparatus 203 generates and stores an empty node ID list (step S2304). The data aggregating apparatus 203 stores as a completed calibration, the calibration ID that is being aggregated (step S2305).

After completing the operation at step S2305 or if the calibration ID currently being aggregated is an invalid value (step S2301: YES), the data aggregating apparatus 203 stores the obtained calibration ID as being subject to aggregation (step S2306). After completing the operation at step S2306, the data aggregating apparatus 203 ends the calibration starting process by the data aggregating apparatus. By executing the calibration starting process by the data aggregating apparatus, the data aggregating apparatus 203 is able to prepare for aggregation of calibration request packets.

FIG. 24 is a flowchart (part 1) of an example of a procedure of the calibration aggregating process by the data aggregating apparatus. FIG. 25 is a flowchart (part 2) of the example of the procedure of the calibration aggregating process by the data aggregating apparatus. The calibration aggregating process by the data aggregating apparatus is a process of aggregating calibration request packets.

The data aggregating apparatus 203 set a variable i to 1 (step S2401). The data aggregating apparatus 203 determines if the variable i is the hop count of the packet or less (step S2402). If the variable i is the hop count of the packet or less (step S2402: YES), the data aggregating apparatus 203 obtains the i-th node ID from the packet (step S2403). The data aggregating apparatus 203 determines whether the obtained node ID is included in the node ID list (step S2404). If the obtained node ID is not included in the node ID list (step S2404: NO), the data aggregating apparatus 203 adds the obtained node ID to the node ID list to thereby store the obtained node ID (step S2405).

After completing the operation at step S2405 or if the obtained node ID is included in the node ID list (step S2404: YES), the data aggregating apparatus 203 increments the variable i (step S2406). The data aggregating apparatus 203 transitions to the operation at step S2402.

If the variable i is greater than the hop count of the packet (step S2402: NO), the data aggregating apparatus 203 counts the number of node IDs in the node ID list (step S2501). The data aggregating apparatus 203 determines if the counted number of node IDs is a given value or greater (step S2502).

If the counted value of the node IDs is the given value or greater (step S2502: YES), the data aggregating apparatus 203 transmits to the user terminal 201, the largest hop count currently stored (step S2503). The data aggregating apparatus 203 stores as a completed calibration, the calibration ID that is being aggregated (step S2504). The data aggregating apparatus 203 stores an invalid value as the calibration ID that is currently being aggregated (step S2505). The data aggregating apparatus 203 discards the node ID list currently stored (step S2506). The data aggregating apparatus 203 generates an empty node ID list (step S2507).

After completing the operation at step S2507 or if the counted number of node IDs is less than the given value (step S2502: NO), the data aggregating apparatus 203 ends the calibration aggregating process by the data aggregating apparatus. By executing the calibration aggregating process by the data aggregating apparatus, the data aggregating apparatus 203 is able to aggregate calibration request packets and accumulate aggregation results in a node ID list.

FIG. 26 is a flowchart of one example of a procedure of the data collection request process by the data aggregating apparatus. The data collection request process by the data aggregating apparatus is a process performed when a data collection request packet has been received.

The data aggregating apparatus 203 obtains the collection ID from the packet (step S2601). The data aggregating apparatus 203 determines whether the obtained collection ID matches the collection ID currently being aggregated (step S2602). If the obtained collection ID does not match the collection ID that is currently being aggregated (step S2602: NO), the data aggregating apparatus 203 determines whether the obtained collection ID is included in an ID group stored as completed collections (step S2603). If the obtained collection ID is not included in the ID group stored as completed collections (step S2603: NO), the data aggregating apparatus 203 determines whether the collection ID currently being aggregated is an invalid value (step S2604).

If the collection ID that is currently being aggregated is not an invalid value (step S2604: NO), the data aggregating apparatus 203 transmits to the user terminal 201, the node ID list and the collected data list that are currently stored (step S2605). The data aggregating apparatus 203 discards the node ID list and the collected data list that are currently stored (step S2606). The data aggregating apparatus 203 generates and stores an empty node ID list and collected data list (step S2607). The data aggregating apparatus 203 stores as a completed collection, the collection ID that is being aggregated (step S2608).

After completing the operation at step S2608 or if the collection ID that is currently being collected is an invalid value (step S2604: YES), the data aggregating apparatus 203 stores the obtained collection ID as being subject to aggregation (step S2609).

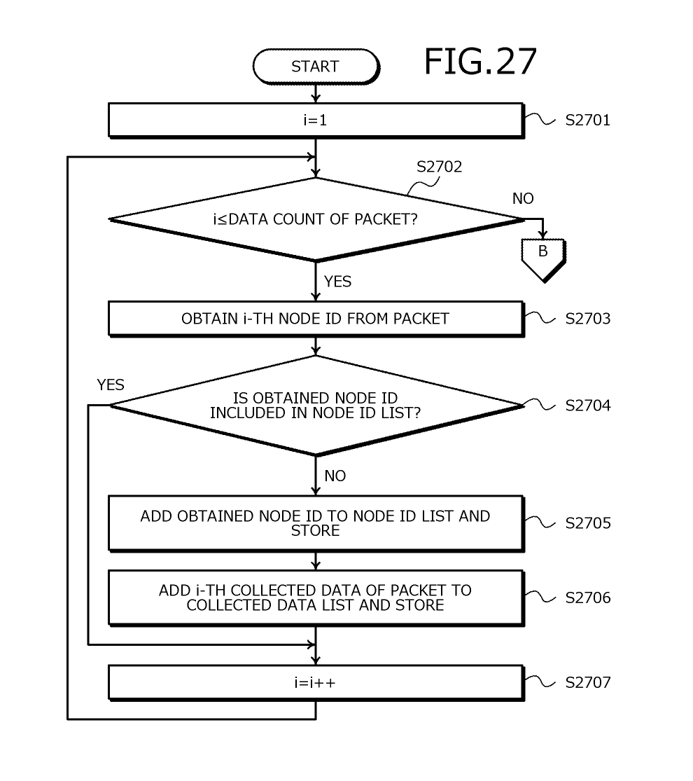

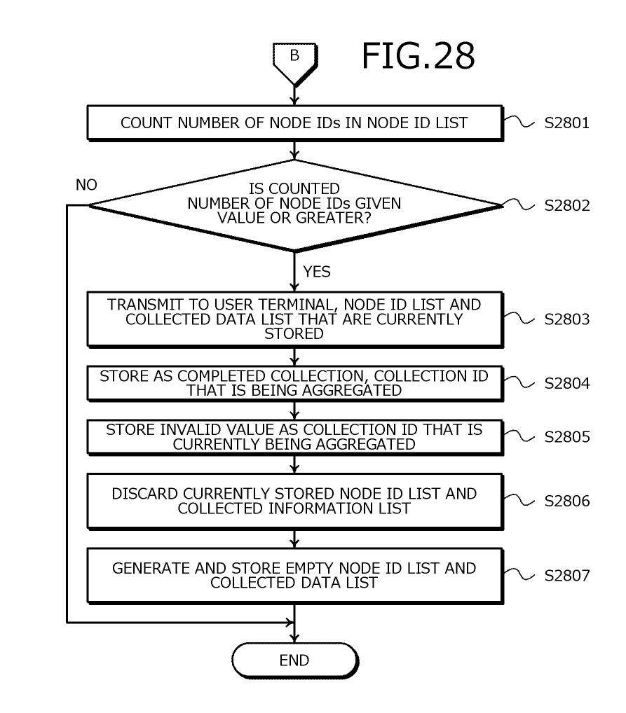

After completing the operation at step S2609 or if the obtained collection ID matches the collection ID that is currently being aggregated (step S2602: YES), the data aggregating apparatus 203 executes a data aggregating process (step S2610). The data aggregating process will be described hereinafter with reference to FIGS. 27 and 28.

After completing the operation at step S2610 or if the obtained collection ID is included in the ID group stored as completed collections (step S2603: YES), the data aggregating apparatus 203 ends the data collection request process by the data aggregating apparatus. By executing the data collection request process by the data aggregating apparatus, the data aggregating apparatus 203 is able to process data collection request packets.

FIG. 27 is a flowchart (part 1) of an example of a procedure of the data aggregating process by the data aggregating apparatus. FIG. 28 is a flowchart (part 2) of the example of the procedure of the data aggregating process by the data aggregating apparatus. The data aggregating process by the data aggregating apparatus is a process of aggregating data collection request packets.

Here, operations at step S2701 to step S2705, step S2707, step S2801, and step S2802 are the same as the operations at step S2401 to step S2406, step S2501, step S2502 and therefore, description thereof is omitted hereinafter.

After completing the operation at step S2705, the data aggregating apparatus 203 adds the i-th collected data of the packet to the collected data list to thereby store the i-th collected data (step S2706). After completing the operation at step S2706, the data aggregating apparatus 203 transitions to the operation at step S2707.

In the case of step S2802: YES, the data aggregating apparatus 203 transmits to the user terminal 201, the node ID list and the collected data list that are currently stored (step S2803). The data aggregating apparatus 203 stores as a completed collection, the collection ID that is being aggregated (step S2804). The data aggregating apparatus 203 stores an invalid value as the collection ID that is currently being aggregated (step S2805). The data aggregating apparatus 203 discards the node ID list and the collected data list that are currently stored (step S2806). The data aggregating apparatus 203 generates and stores an empty node ID list and collected data list (step S2807).

After completing the operation at step S2807 or in the case of step S2802: NO, the data aggregating apparatus 203 ends the data aggregating process by the data aggregating apparatus. By executing the data aggregating process by the data aggregating apparatus, the data aggregating apparatus 203 is able to aggregate data collection request packets and accumulate aggregation results in a node ID list and collected data list.

As described, according to the sensor network system 200, the user terminal 201 transmits a data collection request to the node group; after receiving data from the node group, the data aggregating apparatus 203 uses the network 103 and directly transmits reception information to the communications apparatus 101. As a result, the sensor network system 200 is able to bypass the node group, which has strict communications constraints, and notify the communications apparatus 101 of the arrival of the data. The data aggregating apparatus 203 is able to efficiently perform data collection since the data aggregating apparatus 203 no longer resends the data despite receiving the data from the node group.

Further, according to the sensor network system 200, the data collection requesting apparatus 202 may determine whether reception information is received from the data aggregating apparatus 203 before the collection time calculated using the hop count and starting after transmission of the data collection request elapses. As a result, the sensor network system 200 is able to standby for a period during which data corresponding to the data collection request may be expected to be received. If the collection time elapses without receipt of the reception information, a failure in the data collection has occurred and accuracy in determining the success and failure of data collection in the sensor network system 200 can be improved.

According to the sensor network system 200, when the data aggregating apparatus 203 determines that data corresponding to the data collection request has not been received, the data collection requesting apparatus 202 may transmit the data collection request. As a result, even when failing to collect data, the sensor network system 200 is able to again perform data collection.

According to the sensor network system 200, for each integer from 0 to the hop count and based on a prescribed size of the data of a cumulative count of the integers and the communication time per unit data, the communication time for the cumulative count of data may be calculated, and the communication time for the cumulative count of data may be cumulated to calculate the collection time. As a result, since the sensor network system 200 estimates the collection time taking into consideration, the data volume, which increases with each hop, the sensor network system 200 is able to estimate a more accurate period during which the data may be expected to be received.

According to the sensor network system 200, when the data collection requesting apparatus 202 receives sensor data of a count greater than or equal to a given count based on the number of nodes, the data collection requesting apparatus 202 may transmit reception information to the user terminal 201. As a result, the sensor network system 200 can be built using low cost nodes of a low yield ratio since data does not have to be collected from all the nodes and it is acceptable if some of the nodes fail. Furthermore, even if data is not collected from all of the nodes, analysis of some occurrence in a given region is possible by collecting some extent of the data.

Further, the sensor network system 200 can build a network even when nodes are randomly interspersed and nearby nodes are not identified.

In the sensor network system 200 according to the first embodiment, the user terminal 201 recursively retransmits a data collection request if collected data is not received within a maximum waiting period, after transmitting a data collection request packet. Nonetheless, the sensor network system 200 according to the first embodiment becomes unable to transmit collected data to the user terminal in a case where the largest hop count increases as a result of the path detouring such as when the path between nodes changes consequent to a node failing or some condition.

Thus, a sensor network system 2900 according to a second embodiment performs recalibration when despite repeated attempts of a preset number, the user terminal 201 is unable to receive collected data. Portions identical to portions described in the first embodiment are given the same reference numerals used in the first embodiment and description thereof is omitted hereinafter.

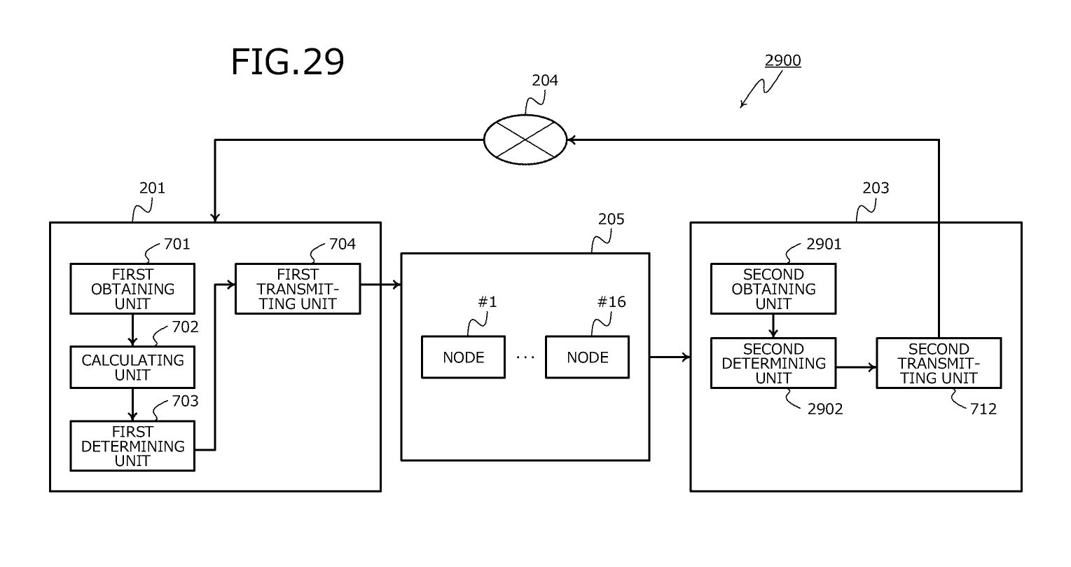

FIG. 29 is a block diagram of a functional example of the sensor network system according to the second embodiment. The sensor network system 2900 has the first obtaining unit 701 to the first transmitting unit 704, a second obtaining unit 2901, a second determining unit 2902, and the second transmitting unit 712. The second obtaining unit 2901, the second determining unit 2902, and the second transmitting unit 712 are functions of the data aggregating apparatus 203.

The second obtaining unit 2901 obtains a count of nodes on one or more paths in the network 205, through which a signal transmitted from the user terminal 201 passes while being transferred to the data aggregating apparatus 203. Concerning nodes that are on plural paths, the count may exclude redundant nodes. The obtained node count is stored to a storage area such as the RAM 503, the large capacity non-volatile memory 504, etc.

Further, sensor data corresponding to a data collection request and transferred by multihop communication among nodes on the second network is assumed to be received. In this case, the second determining unit 2902 determines if the number of received sensor data is greater than or equal to a given count based on the count of nodes on one or more paths obtained by the second obtaining unit 2901.

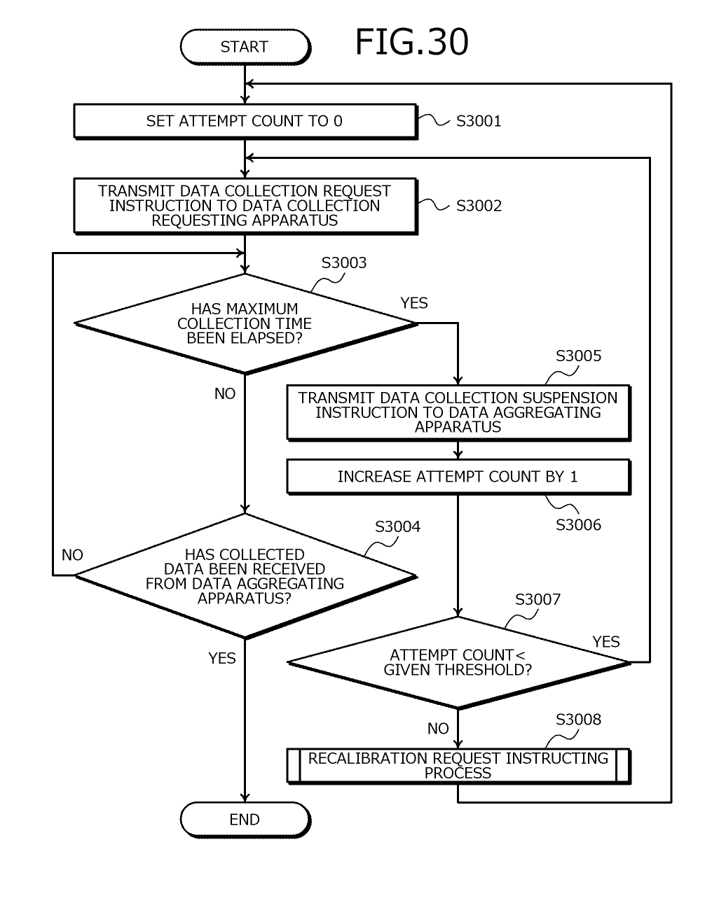

FIG. 30 is a flowchart of one example of the procedure of the calibration request instructing process by the user terminal according to the second embodiment. The calibration request instructing process by the user terminal according to the second embodiment is a process of instructing a calibration request with respect to the sensor network system 2900. Here, operations at step S3002 to step S3005 are identical to the operations at step S1701 to step S1704 and therefore, description thereof is omitted hereinafter.

The user terminal 201 sets an attempt count to 0 (step S3001). After completing the operation at step S3001, the user terminal 201 transitions to the operation at step S3002. After completing the operation at step S3005, the user terminal 201 increases the attempt count by 1 (step S3006). The user terminal 201 determines whether the attempt count is less than a given threshold (step S3007). If the attempt count is less than the given threshold (step S3007: YES), the user terminal 201 transitions to the operation at step S3002.

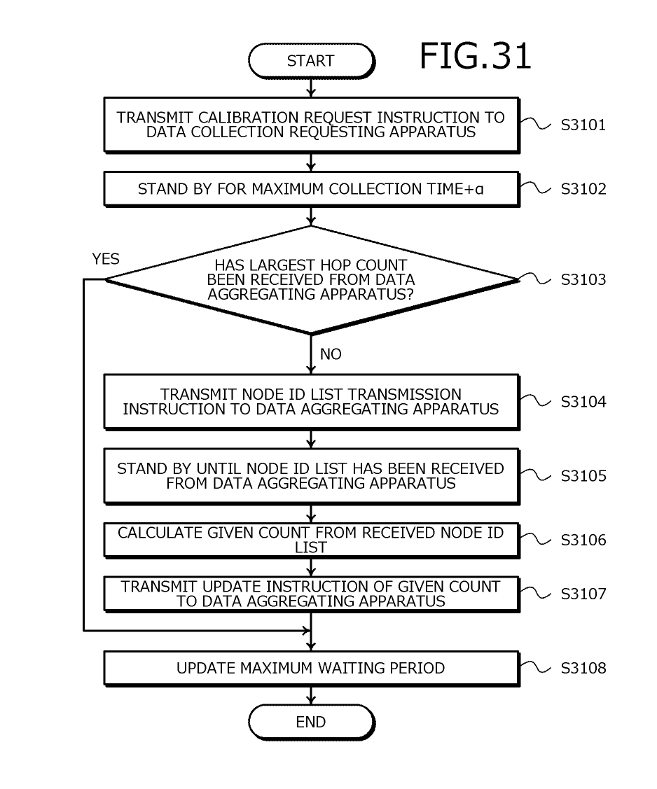

If the attempt count is the given threshold or greater (step S3007: NO), the user terminal 201 executes a recalibration request instructing process (step S3008). Details of the recalibration request instructing process will be described with reference to FIG. 31 hereinafter. After completing the operation at step S3008, the user terminal 201 transitions to the operation at step S3001. By executing the calibration request instructing process by the user terminal according to the second embodiment, the user terminal 201 is able to set an optimal time elapsing until data that corresponds to a data collection request is received. Furthermore, the user terminal 201 is able to perform recalibration to again receive data, in a case where data cannot be received from the data aggregating apparatus 203 for some reason such as an increase of nodes unable to perform communication.

FIG. 31 is a flowchart of one example of a procedure of a recalibration request instructing process by the user terminal. The recalibration request instructing process by the user terminal is a process of performing calibration.

The user terminal 201 transmits a calibration request instruction to the data collection requesting apparatus 202 (step S3101). The user terminal 201 stands by for the maximum collection time+α (step S3102). Here, α may be a given period, a product of the maximum collection time multiplied by a given rate, etc. The user terminal 201 determines whether the largest hop count has been received from the data aggregating apparatus 203 (step S3103).

A case where the largest hop count has not been received (step S3103: NO) means that nodes unable to perform communication consequent to failure, etc. have increased and therefore, the user terminal 201 transmits a node ID list transmission instruction to the data aggregating apparatus 203 (step S3104). The user terminal 201 stands by until the node ID list has been received from the data aggregating apparatus 203 (step S3105). The user terminal 201 calculates a given count from the received node ID list (step S3106). The user terminal 201 transmits an update instruction of the given count to the data aggregating apparatus 203 (step S3107).

After completing the operation at step S3107 or if the largest hop count has been received (step S3103: YES), the user terminal 201 updates the maximum waiting period (step S3108). After completing the operation at step S3108, the user terminal 201 ends the recalibration request instructing process by the user terminal. By executing the recalibration request instructing process by the user terminal, the user terminal 201 is able to change the given count when nodes unable to perform communication have increased.

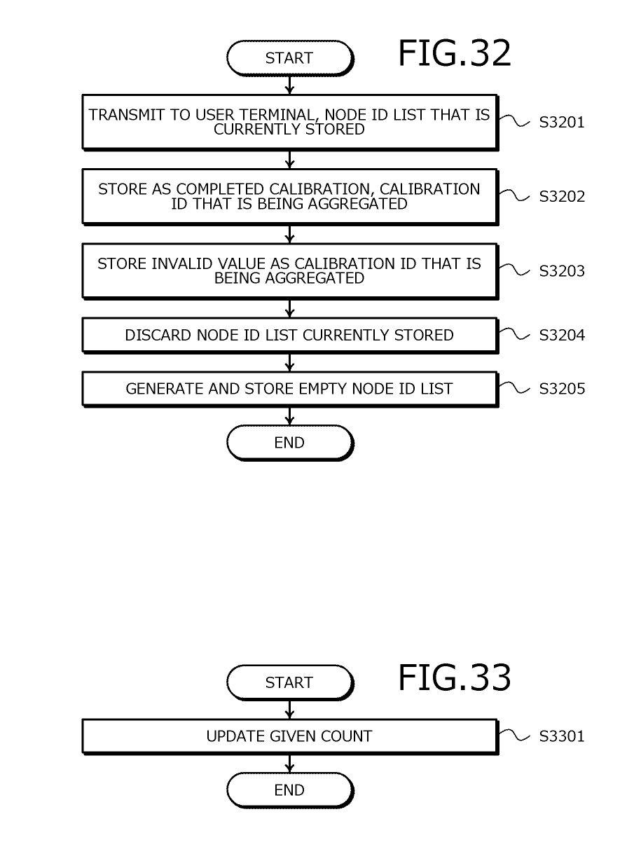

FIG. 32 is a flowchart of one example of a procedure of a node ID transmitting process by the data aggregating apparatus. The node ID transmitting process by the data aggregating apparatus is a process of transmitting a node ID list. Further, the node ID transmitting process by the data aggregating apparatus is executed when after the user terminal 201 has transmitted the node ID list transmission instruction to the data aggregating apparatus 203 at the operation at step S3104, the data aggregating apparatus 203 receives the node ID list transmission instruction.

The data aggregating apparatus 203 transmits to the user terminal 201, the node ID list that is currently stored (step S3201). The data aggregating apparatus 203 stores as a completed calibration, the calibration ID that is being aggregated (step S3202). The data aggregating apparatus 203 stores an invalid value as the calibration ID currently being aggregated (step S3203). The data aggregating apparatus 203 discards the node ID list currently stored (step S3204). The data aggregating apparatus 203 generates and stores an empty node ID list (step S3205).

After completing the operation at step S3205, the data aggregating apparatus 203 ends the node ID transmitting process by the data aggregating apparatus. By executing the node ID transmitting process by the data aggregating apparatus, the data aggregating apparatus 203 is able to transmit the node ID list to the user terminal 201.

FIG. 33 is a flowchart of one example of a procedure of a given count updating process by the data aggregating apparatus. The given count updating process by the data aggregating apparatus is a process of updating by a given count newly calculated by the user terminal 201. Further, the given count updating process by the data aggregating apparatus is executed when the data aggregating apparatus 203 receives an updating instruction of a given count as a result of the user terminal 201 executing the operation at step S3107.

The data aggregating apparatus 203 updates the given count (step S3301). After completing the operation at step S3301, the data aggregating apparatus 203 ends the given count updating process by the data aggregating apparatus. By executing the given count updating process by the data aggregating apparatus, the data aggregating apparatus 203 is able to set an updated given count and transmit collected data to the user terminal 201, even when nodes that have failed have increased.

As described, according to the sensor network system 2900, in a case where the given count is updated and the data collection requesting apparatus 202 receives sensor data of the updated count or greater, reception information may be transmitted to the user terminal 201. As a result, the sensor network system 2900 is able to collect data, even when the hop count has increased consequent to node failure, etc.

The communications method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The communications program may be distributed through a network such as the Internet.

According to one aspect, an effect is achieved in that the efficiency of data collection from nodes having strict communications constraints can be enhanced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communications method comprising:
transmitting a sensor data collection request to a second network that includes a group of nodes having sensors, the transmitting being performed by a first communications apparatus of a plurality of communications apparatuses configured to communicate through a first network; and
transmitting reception information to the first communications apparatus via the first network, when sensor data is received that is transferred by multihop communication among nodes in the second network and corresponds to the sensor data collection request, the reception information indicating reception of the sensor data, and the transmitting of the reception information being performed by a second communications apparatus of the plurality of communications apparatuses.

2. The communications method according to claim 1 and further comprising:
obtaining by the first communications apparatus, a hop count of a signal transmitted from the first communications apparatus and transferred by the multihop communication among the nodes to the second communications apparatus;
calculating by the first communications apparatus, a collection time consumed for collection of the sensor data, the calculating being based on the obtained hop count and a first communication time of communication between the nodes in the second network; and
determining by the first communications apparatus, whether the reception information has been received from the second communications apparatus before the calculated collection time after transmission of the sensor data collection request elapses.

3. The communications method according to claim 2, wherein
the transmitting of the sensor data collection request includes transmitting the sensor data collection request by the first communications apparatus, when at the determining, the first communications apparatus determines that the reception information has not been received before the collection time after the transmission of the sensor data collection request elapses.

4. The communications method according to claim 2 and further comprising
calculating by the first communications apparatus and for each integer from 0 to the hop count, a second communication time of the sensor data of a cumulative count of the integers, the calculating of the second communication time being based on a prescribed size of the sensor data of the cumulative count of the integers and a third communication time per unit data between the nodes of the second network, wherein
the calculating of the collection time includes calculating the collection time by cumulating the second communication time of the sensor data of the cumulative count of the integers, calculated for each integer from 0 to the hop count.

5. The communications method according to claim 1 and further comprising
determining by the second communications apparatus, whether a count of the received sensor data is at least a given count based on a count of the nodes in the second sensor network, when the sensor data is received that is transferred by the multihop communication among the nodes in the second network and corresponds to the sensor data collection request, wherein
the transmitting of the reception information by the second communications apparatus includes transmitting the reception information to the first communications apparatus, via the first network, when at the determining, the second communications apparatus determines that the count of the sensor data is at least the given count.

6. The communications method according to claim 5 and further comprising
obtaining by the second communications apparatus, a count of the nodes on one or more paths in the second network and through which a signal transmitted from the first communications apparatus passes, wherein
the determining of whether the count of the received sensor data is at least the given count includes determining whether the count of the received sensor data is at least the given count based on the obtained count of the nodes on one or more paths, when the sensor data is received that is transferred by the multihop communication among the nodes in the second network and corresponds to the sensor data collection request.

7. The communications method according to claim 1, wherein
the transmitting of the sensor data collection request includes transmitting the sensor data collection request, via the first network, by the first communications apparatus,
the communications method further comprising:
transmitting the sensor data collection request to the second network by a third communications apparatus of the plurality of communications apparatuses, when the third communications apparatus receives the sensor data collection request from the first communications apparatus; and
transmitting to the first communications apparatus, via the first network, information indicating reception of the sensor data that corresponds to the sensor data collection request, when the sensor data that corresponds to the sensor data collection request and that is transferred by the multihop communication among the nodes in the second network is received by the second communications apparatus, the transmitting of the information being performed by the second communications apparatus.

8. A system having a plurality of communications apparatuses configured to communicate through a first network and a group of nodes having sensors and included in a second network, the system comprising:
a first communications apparatus that is among the plurality of communications apparatuses and has a first transmitting circuit configured to transmit a sensor data collection request to the second network; and
a second communications apparatus that is among the plurality of communications apparatuses and has a second transmitting circuit configured to transmit to the first communications apparatus, via the first network, reception information indicating reception of sensor data corresponding to the sensor data collection request, the second communications apparatus transmitting the reception information upon receiving the sensor data that is transferred by multihop communication among the nodes in the second network and that corresponds to the sensor data collection request.

9. A non-transitory, computer-readable recording medium storing therein a communications program that among a plurality of communications apparatuses, causes a second communications apparatus configured to communicate with a first communications apparatus, via a first network, to execute a process comprising:
transmitting reception information to the first communications apparatus via the first network, when sensor data is received that is transferred by multihop communication among nodes in a second network and that corresponds to a sensor data collection request transmitted by the first communications apparatus to the second network that includes the nodes having sensors, the reception information indicating reception of the sensor data that corresponds to the sensor data collection request.
